(19) United States
(12) Patent Application Publication
(10) Pub. No.: US 2025/0150609 A1
(43) Pub. Date: May 8, 2025

(54) APPARATUSES AND METHODS FOR ENCODING AND DECODING A VIDEO USING IN-LOOP FILTERING

(71) Applicant: FRAUNHOFER-GESELLSCHAFT ZUR FOERDERUNG DER ANGEWANDTEN FORSCHUNG E.V., Muenchen (DE)

(72) Inventors: Wang-Q LIM, Berlin (DE); Jonathan PFAFF, Berlin (DE); Bjoern STALLENBERGER, Berlin (DE); Heiko SCHWARZ, Berlin (DE); Detlev MARPE, Berlin (DE); Thomas WIEGAND, Berlin (DE)

(21) Appl. No.: 19/018,293

(22) Filed: Jan. 13, 2025

Related U.S. Application Data
(63) Continuation of application No. PCT/EP2023/069589, filed on Jul. 13, 2023.

(30) Foreign Application Priority Data
Jul. 14, 2022 (EP) 22185052.2

(51) Int. Cl. H04N 19/189; H04N 19/117; H04N 19/82

(52) U.S. Cl. CPC H04N 19/189; H04N 19/117; H04N 19/82

(57) ABSTRACT

Video decoders are described, which use block-based predictive decoding, transform-based residual decoding and a prediction loop, with an in-loop filter being connected in the prediction loop. The decoder performs a mode switching between different modes of the in-loop filter, which differ in computational complexity.

### CROSS-REFERENCE TO RELATED APPLICATIONS

This application is a continuation of copending International Application No. PCT/EP2023/069589, filed Jul. 13, 2023, which is incorporated herein by reference in its entirety, and additionally claims priority from European Application No. 22185052.2, filed Jul. 14, 2022, which is also incorporated herein by reference in its entirety.

### TECHNICAL FIELD

Embodiments of the present invention relate to an apparatus and a method for encoding a a video into a bitstream, an apparatus and a method for decoding a video from a bitstream, and a bitstream having a video encoded thereinto. Some embodiments relate to adaptive loop filtering using a CNN-based classification.

### BACKGROUND OF THE INVENTION

In-loop filters have always formed one of the key building blocks of modern video codecs such as H.264/AVC [1, 2], H.265/HEVC [3, 4] or the recently finalized H.266/VVC [5, 6]. The concept of in-loop filtering is motivated by the observation that in the decoding process of a video signal, specific artefacts, so-called coding artefacts, may occur after the addition of prediction and reconstructed residual. Therefore, one tries to find suitable signal-modifications, called in-loop filters, which can be applied to a reconstructed frame of a video sequence before it is either displayed or used as an input for the prediction of other frames.

A classical example for coding artefacts are artificial edges which can be explained by the block-based structure of the underlying video-codec and which can be mitigated by a deblocking filter [7]. On the other hand, the state-of-the-art Versatile Video Coding Standard (VVC) is characterized by a large amount of different compression tools which all together contribute to its compression efficiency. A simple description and mitigation of the coding artefacts that may be caused by specific combinations of some of these tools with the underlying signal becomes more and more difficult. For these reasons, recent approaches often proceed in a data-driven way [8-10] by training specific Convolutional Neural Networks (CNNs) for in-loop filtering. In [11], a specific design of a data-driven in-loop filter has been presented as a generalization of the Adaptive Loop Filter (ALF) of VVC [12, 13].

Still, there is an ongoing desire to improve video compression, e.g. in terms of a rate-distortion relation, computational effort, and/or complexity.

### SUMMARY

An embodiment may have an apparatus for decoding a video from a bitstream, wherein the apparatus is configured to: reconstruct, based on the bitstream, the video using block-based predictive decoding, transform-based residual decoding and a prediction loop into which an in-loop filter tool is serially connected, the in-loop filter tool having a serial connection of a first in-loop filter and a second in-loop filter, wherein the second in-loop filter is configured to subject pre-reconstructed samples of a current picture to an adaptive in-loop filtering, ALF, wherein the second in-loop filter is configured to perform, based on the bitstream, a mode switching between (alternative 1) one or more first modes of performing the adaptive in-loop filtering, and one or more second modes of performing the adaptive in-loop filtering, wherein the one or more first modes are computationally more complex than the one or more second modes, or between (alternative 2) one or more first modes of performing the adaptive in-loop filtering, and one or more second modes of performing the adaptive in-loop filtering, wherein the one or more first modes are computationally more complex than the one or more second modes, and a third mode of bypassing the second in-loop filter, or between (alternative 3) one or more first modes of performing the adaptive in-loop filtering, with each of the first modes using a CNN, and optionally, a second mode of bypassing the second in-loop filter.

Another embodiment may have an apparatus for encoding a video into a bitstream, wherein the apparatus is configured to: encode, into the bitstream, the video using block-based predictive encoding, transform-based residual encoding and a prediction loop into which an in-loop filter tool is serially connected, the in-loop filter tool having a serial connection of a first in-loop filter and a second in-loop filter, wherein the second in-loop filter is configured to subject pre-reconstructed samples of a current picture to an adaptive in-loop filtering, ALF, wherein the second in-loop filter is configured to perform, and signal in the bitstream, a mode switching between (alternative 1) one or more first modes of performing the adaptive in-loop filtering, and one or more second modes of performing the adaptive in-loop filtering, wherein the one or more first modes are computationally more complex than the one or more second modes, or between (alternative 2) one or more first modes of performing the adaptive in-loop filtering, and one or more second modes of performing the adaptive in-loop filtering, wherein the one or more first modes are computationally more complex than the one or more second modes, and a third mode of bypassing the second in-loop filter, or between (alternative 3) one or more first modes of performing the adaptive in-loop filtering, with each of the first modes using a CNN, and optionally, a second mode of bypassing the second in-loop filter.

Another embodiment may have methods performed by the above apparatus for decoding a video from a bitstream or encoding a video into a bitstream.

Another embodiment may have a method for decoding a video from a bitstream, the method having: reconstruct, based on the bitstream, the video using block-based predictive decoding, transform-based residual decoding and a prediction loop into which an in-loop filter tool is serially connected, the in-loop filter tool having a serial connection of a first in-loop filtering and a second in-loop filtering, wherein the second in-loop filtering is performed by subjecting pre-reconstructed samples of a current picture to an adaptive in-loop filtering, ALF, wherein the second in-loop filtering performs, based on the bitstream, a mode switching between (alternative 1) one or more first modes of performing the adaptive in-loop filtering, and one or more second modes of performing the adaptive in-loop filtering, wherein the one or more first modes are computationally more complex than the one or more second modes, or between (alternative 2) one or more first modes of performing the adaptive in-loop filtering, and one or more second modes of performing the adaptive in-loop filtering, wherein the one or more first modes are computationally more complex than the one or more second modes, and a third mode of bypassing the second in-loop filter, or between (alternative 3) one or more first modes of performing the adaptive in-loop filtering, with each of the first modes using a CNN, and optionally, a second mode of bypassing the second in-loop filter.

Another embodiment may have a method for encoding a video into a bitstream, the method having: encode, into the bitstream, the video using block-based predictive encoding, transform-based residual encoding and a prediction loop into which an in-loop filter tool is serially connected, the in-loop filter tool having a serial connection of a first in-loop filter and a second in-loop filter, wherein the second in-loop filtering is performed by subjecting pre-reconstructed samples of a current picture to an adaptive in-loop filtering, ALF, wherein the second in-loop filtering performs, and signals in the bitstream, a mode switching between (alternative 1) one or more first modes of performing the adaptive in-loop filtering, and one or more second modes of performing the adaptive in-loop filtering, wherein the one or more first modes are computationally more complex than the one or more second modes, or between (alternative 2) one or more first modes of performing the adaptive in-loop filtering, and one or more second modes of performing the adaptive in-loop filtering, wherein the one or more first modes are computationally more complex than the one or more second modes, and a third mode of bypassing the second in-loop filter, or between (alternative 3) one or more first modes of performing the adaptive in-loop filtering, with each of the first modes using a CNN, and optionally, a second mode of bypassing the second in-loop filter.

Another embodiment may have a non-transitory digital storage medium having stored thereon a computer program for performing any of the above methods when the computer program is run by a computer.

Another embodiment may have a bitstream generated by the above apparatus for encoding.

Embodiments of the present invention rely on the idea to use, in a prediction loop, which is part of a coding concept using block-based predictive decoding and transform-based residual decoding, an in-loop filter tool, which performs, for an in-loop filter of the in-loop filter tool, a mode switching between a plurality of modes that differ in complexity. Such mode switching allows an adoption to the coded video signal. The inventors realized that despite the fact that the controlling of the mode switching may increase complexity, the overall reduced computational effort and/or complexity may be reduced, because the computational resources may be distributed more efficiently on individual portions of the video signal. For example, the effect of an in-loop filtering may be higher for some portions, but lower for other ones, so that the possibility of a mode switching between different complexity levels of the in-loop filter may improve the trade-off between a rate-distortion measure and computational effort/complexity. In a first alternative, the modes of different complexity may be provided by a first mode and a second mode of performing the adaptive in-loop filtering, which have different computational complexities. In a second alternative, in addition to the first and the second modes, a bypass mode is provided as a further option for the mode switching. In the bypass mode, computational effort for the respective in-loop filter may be avoided. In a third alternative, the modes of different complexity are provided by one or more first modes, each of which use a CNN for performing the adaptive in-loop filtering and optionally a bypass mode.

Embodiments of the invention provide an apparatus for decoding a video from a bitstream. The apparatus is configured to reconstruct, based on the bitstream, (e.g. according to H.266) the video using block-based predictive decoding, transform-based residual decoding and a prediction loop into which an in-loop filter tool is serially connected, the in-loop filter tool comprising a serial connection of a first in-loop filter and a second in-loop filter. The second in-loop filter is configured to subject pre-reconstructed samples of a current picture to an adaptive in-loop filtering, ALF (e.g. whose filter transfer function is locally adapted). In a first alternative of these embodiments, the second in-loop filter is configured to perform, based on the bitstream, a mode switching between one or more first modes of performing the adaptive in-loop filtering (e.g. for example, mutually differing in terms of complexity), and one or more second modes of performing the adaptive in-loop filtering, wherein the one or more first modes are computationally more complex than the one or more second modes. In a second alternative of these embodiments, the second in-loop filter is configured to perform, based on the bitstream, a mode switching between one or more first modes of performing the adaptive in-loop filtering (e.g. for example, mutually differing in terms of complexity), one or more second modes of performing the adaptive in-loop filtering, wherein the one or more first modes are computationally more complex than the one or more second modes, and a third mode of bypassing the second in-loop filter. In a third alternative of these embodiments, the second in-loop filter is configured to perform, based on the bitstream, a mode switching between one or more first modes of performing the adaptive in-loop filtering (e.g. for example, more than one and mutually differing in terms of complexity), with each of the first modes using a CNN, and optionally, a second mode of bypassing the second in-loop filter. For example in the third alternative, the mode switching may be performed between one first mode using a CNN and the bypass mode, or between a plurality of the first modes, each of which using a CNN, the CNNs having different computational complexities, or between a plurality of the first modes, each of which uses a CNN, and the bypass mode.

According to embodiments, the one or more first modes and/or the one or more second modes involve the second in-loop filter assigning a classification to pre-reconstructed samples of the current picture and filtering the pre-reconstructed samples with a filter transfer function which is adapted to the classification. The manner of performing the classification and/or the filter transfer functions may be specific to the respective modes.

For example, the classification of the one or more first modes is a soft-classification and/or the classification of the one or more second modes is a hard-classification. A soft-classification may be computationally more complex compared to a hard-classification, but may provide a better adaptation to the video signal, thereby providing a more accurate prediction and as a result a better rate-distortion of the encoded video signal.

According to an embodiment, the apparatus is configured to perform the mode switching (e.g. inter alias) based on an estimation of a measure of complexity (e.g. number of multiplications per sample) incurred by the second in-loop filter or the one or more first modes of the second in-loop filter within a predetermined video or picture section so far by disabling the one or more first modes, or any first mode (i.e. all those) exceeding a predetermined complexity for the predetermined video or picture section if the estimation fulfills a predetermined criterion (e.g. exceeds a threshold). Such a switching may prevent the coding complexity of exceeding a certain complexity threshold and thus exceeding resources available for the decoding, but the mode switching may allow still using higher complexity in-loop filtering modes, such as CNN based modes, for portions of the video, in which the usage of these higher complexity modes incur a comparably low complexity.

According to an embodiment, the apparatus is configured to perform the mode switching (e.g. inter alias) based on a measure for prediction quality or prediction imperfection within a predetermined picture area by disabling the one or more first modes, or any first mode exceeding the predetermined complexity, for the predetermined picture area if the measure for prediction quality or prediction imperfection fulfills a further predetermined criterion. For example, in case of a comparably high prediction quality, the impact of the in-loop filtering may be comparably low, so that the trade-off between complexity and rate-distortion may be improved by choosing a low-complexity filtering mode. For example, the quality for the prediction quality may be measured in terms of a metric of the prediction residuum.

According to an embodiment, the apparatus is configured to perform the mode switching based on prediction type or inter-prediction hierarchy level of a picture by disabling the one or more first modes, or any first mode exceeding a predetermined complexity for the picture if the measure for prediction quality or prediction imperfection fulfills a even further predetermined criterion. That is, for example, the consideration of the prediction quality may be combined with a conditioning on the prediction type or hierarchy level, so that different criterions may be applied for different prediction types or hierarchy levels. This combination allows for using more computational resources in case of prediction types/hierarchy levels of higher impact compared to ones incurring lower impact on the prediction signal, so that the usage of resources may be controlled to provide a good trade-off between complexity and rate-distortion.

According to an embodiment, the apparatus is configured to perform the mode switching in dependence on (e.g. inter alias) whether for a predetermined picture portion at least one reference picture succeeds a picture of the predetermined picture portion in presentation time order by disabling the one or more first modes, or any first mode exceeding the predetermined complexity for the predetermined picture portion if this is the case. Pictures not using reference pictures of later presentation times may be used as reference pictures more frequently, so that a high reconstruction quality of these pictures may have a higher impact compared to pictures using reference pictures of later presentation times. Therefore, spending more computational effort on reconstructing pictures not using reference pictures of later presentation times may provide a good trade-off between complexity and rate-distortion.

According to an embodiment, the apparatus is configured to perform the mode switching in dependence on (e.g. inter alias) whether a further predetermined picture portion is, within at least one block, or completely, intra coded by disabling the one or more first modes, or any first mode exceeding a predetermined complexity for the further predetermined picture portion if this is the case. Artifacts introduced by prediction may be more severe in inter-prediction compared to intra-prediction so that a restriction of the higher complexity first modes to inter-predicted blocks may increase the trade-off between complexity and rate-distortion.

According to embodiments, the above-mentioned signal-modification is generated by a weighted sum of FIR-filterings. The weights may vary per sample and are computed by an offline-trained CNN. They can be interpreted as probabilities for a sample to belong to a specific class.

Embodiments of this invention provide a reduction of the decoder-complexity of [11] by restricting the in-loop filtering process to a specific subset of all reconstructed blocks or by applying the proposed in-loop filter in different complexity configurations to different types of reconstructed blocks. For some embodiments, two main hypotheses that are verified by experiments motivate the design. First, it is assumed that due to the temporal prediction between frames, a removal of compression artefacts by the proposed in-loop filter is particularly important for those frames which are typically referenced most frequently in a typical Random-Access (RA) coding scenario with hierarchical B-pictures. Second, it is assumed that the proposed in-loop filter technology is most effective on those parts of a decoded video sequence where a prediction residual has been transmitted. Therefore, we introduce various settings where the proposed in-loop filter is applied for I-pictures is more complex than the one applied for B-pictures. Furthermore, we disallow the CNN-based in-loop filters for some input blocks, especially ones where the quantized prediction residual is zero. We describe the gain-complexity trade-offs of those settings.

A further embodiment provides an apparatus for encoding a video into a bitstream. The apparatus is configured to encode, into the bitstream, (e.g. according to H.266) the video using block-based predictive encoding, transform-based residual encoding and a prediction loop into which an in-loop filter tool is serially connected, the in-loop filter tool comprising a serial connection of a first in-loop filter and a second in-loop filter. The second in-loop filter is configured to subject pre-reconstructed (in the prediction loop) samples of a current picture to an adaptive in-loop filtering, ALF, (e.g. whose filter transfer function is locally adapted). Further, the second in-loop filter is configured to perform (e.g. by means of RD optimization), and signal in the bitstream, a mode switching according to one of the first, second, and third alternatives described above.

A further embodiment provides a method for decoding a video from a bitstream, wherein the method comprises: reconstruct, based on the bitstream, (e.g. according to H.266) the video using block-based predictive decoding, transform-based residual decoding and a prediction loop into which an in-loop filter tool is serially connected, the in-loop filter tool comprising a serial connection of a first in-loop filtering and a second in-loop filtering. The second in-loop filtering is performed by subjecting pre-reconstructed samples of a current picture to an adaptive in-loop filtering, ALF (e.g. whose filter transfer function is locally adapted). Further, the second in-loop filtering performs, based on the bitstream, a mode switching according to one of the first, second, and third alternatives described above.

A further embodiment provides a method for encoding a video into a bitstream, wherein the method comprises: encode, into the bitstream, (e.g. according to H.266) the video using block-based predictive encoding, transform-based residual encoding and a prediction loop into which an in-loop filter tool is serially connected, the in-loop filter tool comprising a serial connection of a first in-loop filter and a second in-loop filter. The second in-loop filtering is performed by subjecting pre-reconstructed samples of a current picture to an adaptive in-loop filtering, ALF (e.g. whose filter transfer function is locally adapted). Further, the second in-loop filtering performs, and signals in the bitstream, a mode switching according to one of the first, second, and third alternatives described above.

### BRIEF DESCRIPTION OF THE DRAWINGS

Embodiments of the present disclosure are described in more detail below with respect to the figures, among which:

FIG. 1 illustrates an encoder according to an embodiment;

FIG. 2 illustrates a decoder according to an embodiment;

FIG. 3 illustrates a block partitioning according to an embodiment;

FIG. 4 illustrates a decoding according to an embodiment;

FIG. 5 illustrates the second in-loop filter according to an embodiment;

FIG. 6 illustrates an in-loop filtering according to an embodiment;

FIG. 7 illustrates an in-loop filtering according to a further embodiment;

FIG. 8 illustrates an in-loop filtering according to a further embodiment;

FIG. 9 illustrates a CNN-based in-loop filtering according to a further embodiment;

FIG. 10 illustrates an encoder according to an embodiment; and

FIGS. 11A, B illustrate simulation results for embodiments.

### DETAILED DESCRIPTION OF THE INVENTION

Embodiments of the present invention are now described in more detail with reference to the accompanying drawings, in which the same or similar elements or elements that have the same or similar functionality have the same reference signs assigned or are identified with the same name. In the following description, a plurality of details is set forth to provide a thorough explanation of embodiments of the disclosure. However, it will be apparent to one skilled in the art that other embodiments may be implemented without these specific details. In addition, features of the different embodiments described herein may be combined with each other, unless specifically noted otherwise.

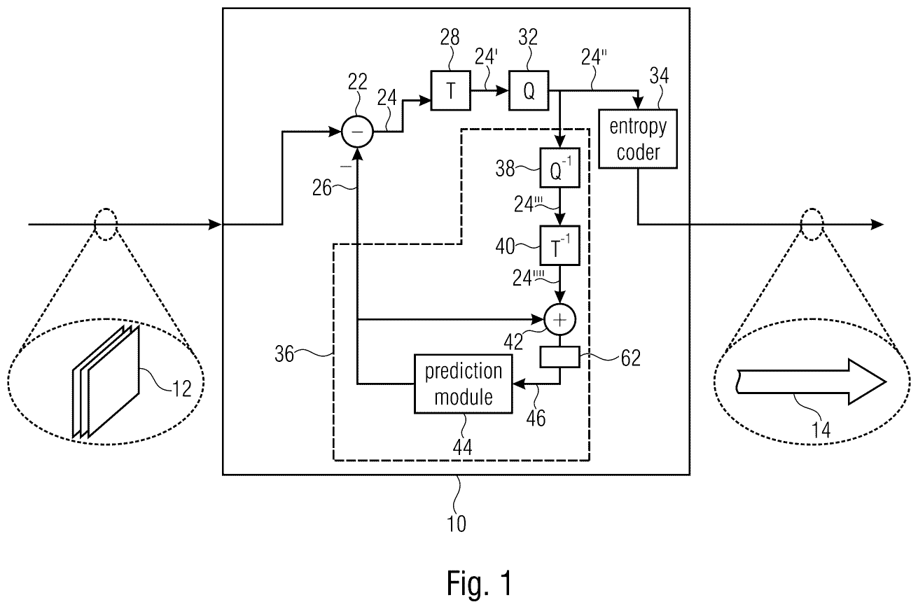

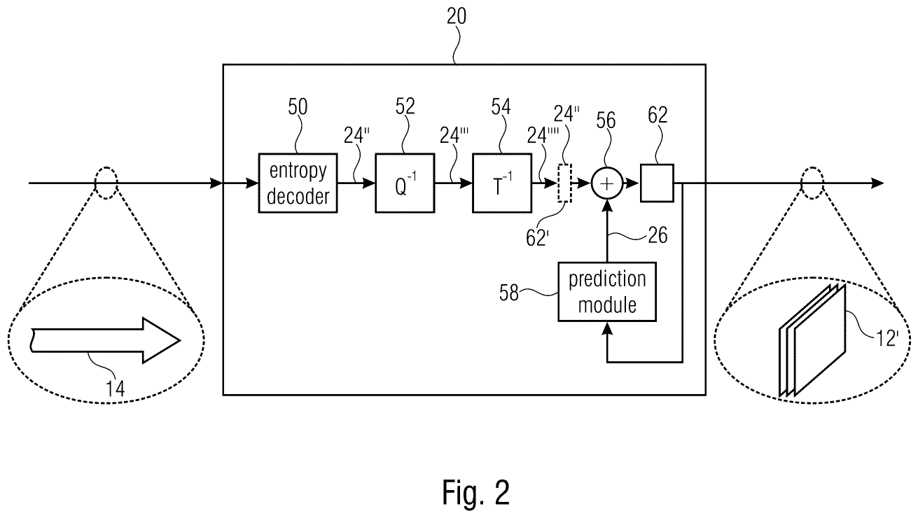

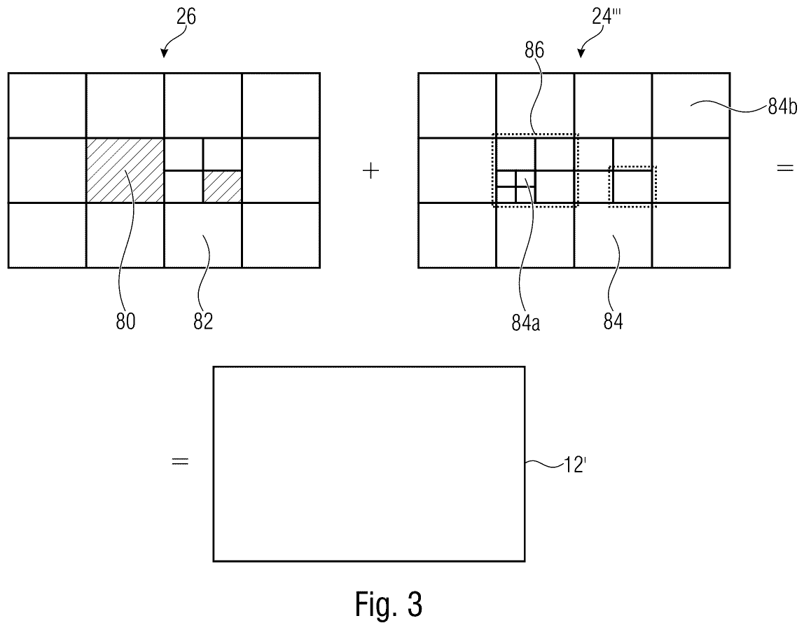

The following description of the figures starts with a presentation of a description of an encoder and a decoder of a block-based predictive codec for coding pictures of a video in order to form an example for a coding framework into which embodiments of the present invention may be built in. The respective encoder and decoder are described with respect to FIG. 1, FIG. 2, and FIG. 3. Thereinafter the description of embodiments of the concept of the present invention is presented along with a description as to how such concepts could be built into the encoder and decoder of FIG. 1, and FIG. 2, respectively, although the embodiments described with the subsequent Figures and following, may also be used to form encoders and decoders not operating according to the coding framework underlying the encoder and decoder of FIG. 1, and FIG. 2.

FIG. 1 shows an apparatus for predictively coding a picture 12 into a data stream 14 exemplarily using transform-based residual coding. The apparatus, or encoder, is indicated using reference sign 10. FIG. 2 shows a corresponding decoder 20, i.e. an apparatus 20 configured to predictively decode the picture 12′ from the data stream 14 also using transform-based residual decoding, wherein the apostrophe has been used to indicate that the picture 12′ as reconstructed by the decoder 20 deviates from picture 12 originally encoded by apparatus 10 in terms of coding loss introduced by a quantization of the prediction residual signal. FIG. 1 and FIG. 2 exemplarily use transform based prediction residual coding, although embodiments of the present application are not restricted to this kind of prediction residual coding. This is true for other details described with respect to FIG. 1, and FIG. 2, too, as will be outlined hereinafter.

The encoder 10 is configured to subject the prediction residual signal to spatial-to-spectral transformation and to encode the prediction residual signal, thus obtained, into the data stream 14. Likewise, the decoder 20 is configured to decode the prediction residual signal from the data stream 14 and subject the prediction residual signal thus obtained to spectral-to-spatial transformation.

Internally, the encoder 10 may comprise a prediction residual signal former 22 which generates a prediction residual 24 so as to measure a deviation of a prediction signal 26 from the original signal, i.e. from the picture 12. The prediction residual signal former 22 may, for instance, be a subtractor which subtracts the prediction signal from the original signal, i.e. from the picture 12. The encoder 10 then further comprises a transformer 28 which subjects the prediction residual signal 24 to a spatial-to-spectral transformation to obtain a spectral-domain prediction residual signal 24′ which is then subject to quantization by a quantizer 32, also comprised by the encoder 10. The thus quantized prediction residual signal 24″ is coded into bitstream 14. To this end, encoder 10 may optionally comprise an entropy coder 34 which entropy codes the prediction residual signal as transformed and quantized into data stream 14. The prediction signal 26 is generated by a prediction stage 36 of encoder 10 on the basis of the prediction residual signal 24″ encoded into, and decodable from, data stream 14. To this end, the prediction stage 36 may internally, as is shown in FIG. 1, comprise a dequantizer 38 which dequantizes prediction residual signal 24″ so as to gain spectral-domain prediction residual signal 24′″, which corresponds to signal 24′ except for quantization loss, followed by an inverse transformer 40 which subjects the latter prediction residual signal 24′″ to an inverse transformation, i.e. a spectral-to-spatial transformation, to obtain prediction residual signal 24″″, which corresponds to the original prediction residual signal 24 except for quantization loss. A combiner 42 of the prediction stage 36 then recombines, such as by addition, the prediction signal 26 and the prediction residual signal 24″″ so as to obtain a reconstructed signal 46, i.e. a reconstruction of the original signal 12. Reconstructed signal 46 may correspond to signal 12′. A prediction module 44 of prediction stage 36 then generates the prediction signal 26 on the basis of signal 46 by using, for instance, spatial prediction, i.e. intra-picture prediction, and/or temporal prediction, i.e. inter-picture prediction.

Likewise, decoder 20, as shown in FIG. 2, may be internally composed of components corresponding to, and interconnected in a manner corresponding to, prediction stage 36. In particular, entropy decoder 50 of decoder 20 may entropy decode the quantized spectral-domain prediction residual signal 24″ from the data stream, whereupon dequantizer 52, inverse transformer 54, combiner 56 and prediction module 58, interconnected and cooperating in the manner described above with respect to the modules of prediction stage 36, recover the reconstructed signal on the basis of prediction residual signal 24″ so that, as shown in FIG. 2, the output of combiner 56 results in the reconstructed signal, namely picture 12′.

Although not specifically described above, it is readily clear that the encoder 10 may set some coding parameters including, for instance, prediction modes, motion parameters and the like, according to some optimization scheme such as, for instance, in a manner optimizing some rate and distortion related criterion, i.e. coding cost. For example, encoder 10 and decoder 20 and the corresponding modules 44, 58, respectively, may support different prediction modes such as intra-coding modes and inter-coding modes. The granularity at which encoder and decoder switch between these prediction mode types may correspond to a subdivision of picture 12 and 12′, respectively, into coding segments or coding blocks. In units of these coding segments, for instance, the picture may be subdivided into blocks being intra-coded and blocks being inter-coded. Intra-coded blocks are predicted on the basis of a spatial, already coded/decoded neighborhood of the respective block as is outlined in more detail below. Several intra-coding modes may exist and be selected for a respective intra-coded segment including directional or angular intra-coding modes according to which the respective segment is filled by extrapolating the sample values of the neighborhood along a certain direction which is specific for the respective directional intra-coding mode, into the respective intra-coded segment. The intra-coding modes may, for instance, also comprise one or more further modes such as a DC coding mode, according to which the prediction for the respective intra-coded block assigns a DC value to all samples within the respective intra-coded segment, and/or a planar intra-coding mode according to which the prediction of the respective block is approximated or determined to be a spatial distribution of sample values described by a two-dimensional linear function over the sample positions of the respective intra-coded block with driving tilt and offset of the plane defined by the two-dimensional linear function on the basis of the neighboring samples. Compared thereto, inter-coded blocks may be predicted, for instance, temporally. For inter-coded blocks, motion vectors may be signaled within the data stream, the motion vectors indicating the spatial displacement of the portion of a previously coded picture of the video to which picture 12 belongs, at which the previously coded/decoded picture is sampled in order to obtain the prediction signal for the respective inter-coded block. This means, in addition to the residual signal coding comprised by data stream 14, such as the entropy-coded transform coefficient levels representing the quantized spectral-domain prediction residual signal 24″, data stream 14 may have encoded thereinto coding mode parameters for assigning the coding modes to the various blocks, prediction parameters for some of the blocks, such as motion parameters for inter-coded segments, and optional further parameters such as parameters for controlling and signaling the subdivision of picture 12 and 12′, respectively, into the segments. The decoder 20 uses these parameters to subdivide the picture in the same manner as the encoder did, to assign the same prediction modes to the segments, and to perform the same prediction to result in the same prediction signal.

FIG. 3 illustrates the relationship between the reconstructed signal, i.e. the reconstructed picture 12′, on the one hand, and the combination of the prediction residual signal 24″″ as signaled in the data stream 14, and the prediction signal 26, on the other hand. As already denoted above, the combination may be an addition. The prediction signal 26 is illustrated in FIG. 3 as a subdivision of the picture area into intra-coded blocks which are illustratively indicated using hatching, and inter-coded blocks which are illustratively indicated not-hatched. The subdivision may be any subdivision, such as a regular subdivision of the picture area into rows and columns of square blocks or non-square blocks, or a multi-tree subdivision of picture 12 from a tree root block into a plurality of leaf blocks of varying size, such as a quadtree subdivision or the like, wherein a mixture thereof is illustrated in FIG. 3 in which the picture area is first subdivided into rows and columns of tree root blocks which are then further subdivided in accordance with a recursive multi-tree subdivisioning into one or more leaf blocks.

Again, data stream 14 may have an intra-coding mode coded thereinto for intra-coded blocks 80, which assigns one of several supported intra-coding modes to the respective intra-coded block 80. For inter-coded blocks 82, the data stream 14 may have one or more motion parameters coded thereinto. Generally speaking, inter-coded blocks 82 are not restricted to being temporally coded. Alternatively, inter-coded blocks 82 may be any block predicted from previously coded portions beyond the current picture 12 itself, such as previously coded pictures of a video to which picture 12 belongs, or picture of another view or an hierarchically lower layer in the case of encoder and decoder being scalable encoders and decoders, respectively.

The prediction residual signal 24″″ in FIG. 3 is also illustrated as a subdivision of the picture area into blocks 84. These blocks might be called transform blocks in order to distinguish same from the coding blocks 80 and 82. In effect, FIG. 3 illustrates that encoder 10 and decoder 20 may use two different subdivisions of picture 12 and picture 12′, respectively, into blocks, namely one subdivisioning into coding blocks 80 and 82, respectively, and another subdivision into transform blocks 84. Both subdivisions might be the same, i.e. each coding block 80 and 82, may concurrently form a transform block 84, but FIG. 3 illustrates the case where, for instance, a subdivision into transform blocks 84 forms an extension of the subdivision into coding blocks 80, 82 so that any border between two blocks of blocks 80 and 82 overlays a border between two blocks 84, or alternatively speaking each block 80, 82 either coincides with one of the transform blocks 84 or coincides with a cluster of transform blocks 84. However, the subdivisions may also be determined or selected independent from each other so that transform blocks 84 could alternatively cross block borders between blocks 80, 82. As far as the subdivision into transform blocks 84 is concerned, similar statements are thus true as those brought forward with respect to the subdivision into blocks 80, 82, i.e. the blocks 84 may be the result of a regular subdivision of picture area into blocks (with or without arrangement into rows and columns), the result of a recursive multi-tree subdivisioning of the picture area, or a combination thereof or any other sort of blockation. Just as an aside, it is noted that blocks 80, 82 and 84 are not restricted to being of quadratic, rectangular or any other shape.

FIG. 3 further illustrates that the combination of the prediction signal 26 and the prediction residual signal 24″″ directly results in the reconstructed signal 12′. However, it should be noted that more than one prediction signal 26 may be combined with the prediction residual signal 24″″ to result into picture 12′ in accordance with alternative embodiments.

In FIG. 3, the transform blocks 84 shall have the following significance. Transformer 28 and inverse transformer 54 perform their transformations in units of these transform blocks 84. For instance, many codecs use some sort of DST or DCT for all transform blocks 84. Some codecs allow for skipping the transformation so that, for some of the transform blocks 84, the prediction residual signal is coded in the spatial domain directly. However, in accordance with embodiments described below, encoder 10 and decoder 20 are configured in such a manner that they support several transforms. For example, the transforms supported by encoder 10 and decoder 20 could comprise:
DCT-II (or DCT-III), where DCT stands for Discrete Cosine Transform
DST-IV, where DST stands for Discrete Sine Transform
DCT-IV
DST-VII
Identity Transformation (IT)

Naturally, while transformer 28 would support all of the forward transform versions of these transforms, the decoder 20 or inverse transformer 54 would support the corresponding backward or inverse versions thereof:
Inverse DCT-II (or inverse DCT-III)
Inverse DST-IV
Inverse DCT-IV
Inverse DST-VII
Identity Transformation (IT)

The subsequent description provides more details on which transforms could be supported by encoder 10 and decoder 20. In any case, it should be noted that the set of supported transforms may comprise merely one transform such as one spectral-to-spatial or spatial-to-spectral transform.

As already outlined above, FIG. 1, FIG. 2 and FIG. 3 have been presented as an example where the inventive concept described further below may be implemented in order to form specific examples for encoders and decoders according to the present application. Insofar, the encoder and decoder of FIG. 1, and FIG. 2, respectively, may represent possible implementations of the encoders and decoders described herein below. FIG. 1, and FIG. 2 are, however, only examples. An encoder according to embodiments of the present application may, however, perform encoding of a picture 12 using the concept outlined in more detail below and being different from the encoder of FIG. 1 such as, for instance, in that same is no video encoder, but a still picture encoder, in that same does not support inter-prediction, or in that the sub-division into blocks 80 is performed in a manner different than exemplified in FIG. 3. Likewise, decoders according to embodiments of the present application may perform block-based decoding of picture 12′ from data stream 14 using the coding concept further outlined below, but may differ, for instance, from the decoder 20 of FIG. 2 in that same is no video decoder, but a still picture decoder, in that same does not support intra-prediction, or in that same sub-divides picture 12′ into blocks in a manner different than described with respect to FIG. 3, for instance.

As illustrated in FIG. 2, decoder 20 may further comprise a filtering module 62, which filters the reconstructed signal 12′, the prediction 58 being performed based on the filtered reconstructed signal 12′. Alternatively or additionally, filtering may be performed prior to the combination 56, i.e. the inversely quantized and retransformed signal 24″″ may be subjected to the filtering prior to combination 56 with the prediction signal 26, as illustrated by filtering module 62′ in FIG. 2. Similarly, encoder 10 of FIG. 1 may comprise a filtering module 62, which may perform the same filtering as filtering module 62 of decoder 20, in the prediction stage 36 to filter the reconstructed signal 46. Additionally or alternatively, the prediction residual signal 24″″ may be subjected to filtering prior to combiner 42 (not shown in FIG. 1), as mentioned with respect to the decoder 20. As the filtering is performed in the prediction loop provided by prediction stage 36 (e.g., in combination with operator 22, transformer 28, and quantizer 32), the filtering by filtering module 62 and/or filtering module 62′ may be referred to as in-loop filtering. Accordingly, embodiments of the invention may optionally be implemented as described with respect to FIGS. 1, 2, and 3, wherein the in-loop filtering may refer to filtering modules 62 and/or 62′.

In the following, embodiments of the invention are described, which may optionally be implemented as described with respect to FIG. 1, FIG. 2, and/or FIG. 3, wherein the features described above may be combined with the embodiments described below individually or in combination with each other. Same reference signs as in FIG. 1, FIG. 2, and FIG. 3 will be used in the following figures to indicate correspondences, however, again, it is noted, that these correspondences are optional.

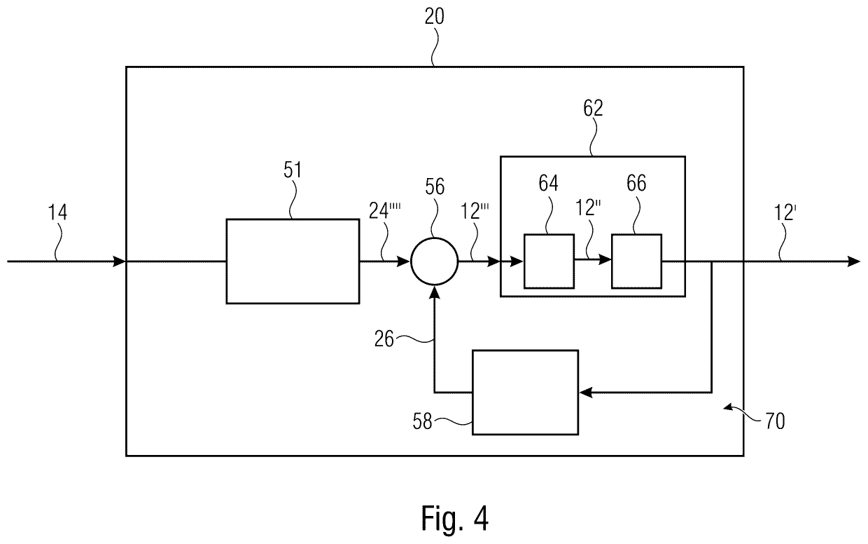

FIG. 4 illustrates an apparatus 20 for decoding a video from a bitstream 14 according to an embodiment. Apparatus 20 may be referred to as decoder 20, and may optionally but not necessarily be implemented like decoder 20 of FIG. 2. Decoder 20 is configured to reconstruct a current picture, represented by the reconstructed signal 12′ in FIG. 4, of the video based on the bitstream 14 using block-based predictive decoding, transform-based residual decoding and a prediction loop 70. Prediction loop 70 may comprise a prediction module 58, e.g., as described with respect to FIG. 2. For example, the prediction loop 70 may be formed in that prediction module 58 may use the reconstructed signal 12′, representing a reconstructed portion of the video, for deriving a prediction signal 26, which is used for reconstruction of a portion of the video following the already reconstructed portion in coding order, e.g. by combining the prediction signal 26, using operator 56, with a residual signal 24″″ reconstructed from the bitstream 14. The portions may be part of (or represent) different pictures, in which case the prediction may be referred to as temporal prediction or inter-prediction, i.e. a reconstructed picture or a portion thereof may be used by prediction module 58 for predicting a picture (or a portion thereof) following the current picture in coding order. Alternatively, the portions may be different blocks of the same picture, in which case the prediction may be referred to as intra-prediction. Prediction loop 70 may also combine different types of prediction. For example, the prediction loop 70 may be implemented as described with respect to FIG. 1, FIG. 2 and FIG. 3.

Decoder 20 may further comprise, as illustrated in FIG. 4, a decoding stage 51, which may reconstruct a residual signal 24″″ from the bitstream, which may be combined, by operator 56, with a prediction signal 26 provided by the prediction module 58. For example, decoding stage 51 may comprise entropy decoder 50, dequantizer 52, and inverse transformer 54, and operator 56 may correspond to combiner 56 described with respect to FIG. 2.

Insofar, the block-based predictive decoding and the transform-based residual decoding may be performed by decoding stage 51, e.g. in combination with the prediction loop 70, in particular in combination with the prediction module 58. It is noted however, that the splitting into decoding stage 51 and prediction loop 70, as it is illustrated in FIG. 4, is exemplarily.

Within the prediction loop 70, an in-loop filter tool 62 is serially connected. The in-loop filter tool comprises a serial connection of a first in-loop filter 64 and a second in-loop filter 66. The second in-loop filter 66 is configured to subject pre-reconstructed samples 12″ of a current picture to an adaptive in-loop filtering, ALF (e.g. whose filter transfer function is locally adapted). For example, the pre-reconstructed samples 12″ may represent reconstructed samples of the current picture before being filtered by the second in-loop filter 66.

For example, the pre-reconstructed samples 12″ may be provided by the first in-loop filter 64, which may derive the pre-reconstructed samples by filtering pre-reconstructed samples 12′″, which may be provided by operator 56 based on the reconstructed residual signal 24″″ and based on the prediction signal 26.

For example, the first in-loop filter 64 may be a static filter or an adaptive filter. The first in-loop filter may be

[symbol]

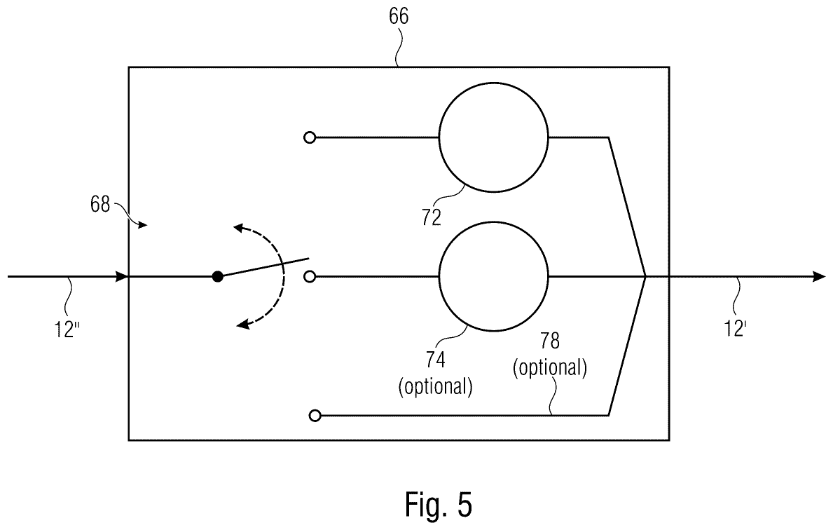

FIG. 5 illustrates further details of the second in-loop filter 66 according to embodiments. The second in-loop filter 66 performs a mode switching 68 based on the bitstream. For example, decoder 20 may derive information, based on which one of a set of possible modes of the second in-loop filter 66 is selected, from the bitstream 14.

According to a first alternative, the second in-loop filter performs the mode-switching 68 between one or more first modes 72 of performing the adaptive in-loop filtering, the first modes 72, for example, mutually differing in terms of complexity, and one or more second modes 74 of performing the adaptive in-loop filtering. According to this embodiment, the one or more first modes 72 are computationally more complex than the one or more second modes 74. FIG. 5 illustrates the exemplary case of each one of the first modes 72 and second modes 74, in which case the mode switching 68 would be performed between two modes, first mode 72 and second mode 74. In further examples, the second in-loop filter may have more than one of the first modes 72 and/or more than one of the second modes 74, in which case the mode switching 68 is performed between a correspondingly higher number of modes.

According to a second alternative, the second in-loop filter may have, in addition to the one or more first modes 72 and one or more second modes 74, a third mode of bypassing the second in-loop filter, referred to as bypass mode 78, which is illustrated as an option in FIG. 5. In other words, according to this alternative, the second in-loop filter 66 performs the mode-switching 68 between the one or more first modes 72 of performing the adaptive in-loop filtering (the first modes 72, for example, mutually differing in terms of complexity), the one or more second modes 74 of performing the adaptive in-loop filtering, and the bypass mode 78.

According to a third alternative, the second in-loop filter may perform the mode switching 68 between the one or more first modes 72 (e.g., more than one first modes 72) and the bypass mode 78. According to this embodiment, each of the one or more first modes uses a CNN. Again, the first modes 72 may mutually differ in terms of complexity, e.g. in terms of complexity of the CNN.

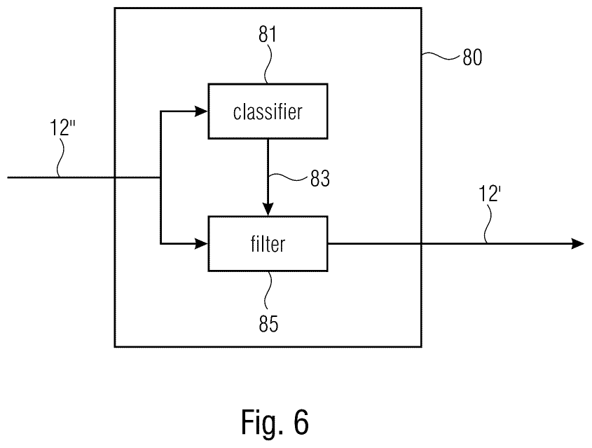

FIG. 6 illustrates an in-loop filtering module 80 according to an embodiment. In-loop filtering module 80 may be an example of how the in-loop filtering is performed by the second in-loop filter 66 in the one or more first modes 72 and/or in the one or more second modes 74. That is, filtering module 80 may illustrate the in-loop filtering for a specific out of the one or more first and/or one or more second modes. In-loop filtering module 80 comprises a classifier 81, which classifies pre-reconstructed samples 12″ of the current picture to provide a classification 83. For example, the classification is performed sample-wise, i.e. classifier 81 may individually assign a class to each of the samples, for which the mode, to which filtering module 80 belongs, is selected. For example, classifier 81 provides a classification 83 for each pre-reconstructed sample 12″, to which the mode of filtering module 80 is applied.

Please note that for sample-wise classification, the input for classifier 81 may still include more than a single sample. For example, the classification may be performed on pre-reconstructed samples 12′ belonging to the entire current picture, or to a portion thereof, such as a block. As an output, a classification 83 may be provided individually for each sample. In examples, for the classification of each of the samples a neighborhood of the sample may be considered by the classification. E.g., the neighborhood may be a region within a sample array of the current picture, within which region the sample is located.

Filtering module further 80 uses a filter 85 for filtering the pre-reconstructed samples 12″ to obtain reconstructed samples 12′. For each sample 12″, the filter 85 may be selected, or adapted (e.g. by selecting a parametrization for the filter) based on the classification 83 selected for the sample. Classifier 81 and filter 85 may be specific to the mode out of the first and second modes. In other words, filtering module 80 may represent a description for each of the first modes 72 and/or second modes 74, where the implementation of the classifier 81 and/or the filter 85 may differ between the modes.

Thus, according to an embodiment, the one or more first modes 72 involve the second in-loop filter 66 assigning a classification 83 to pre-reconstructed samples 12″ of the current picture and filtering 85 the pre-reconstructed samples 12″ with a filter transfer function which is adapted to the classification 83.

According to an embodiment, the classification 81 of the one or more first modes 72 is a soft-classification.

According to an embodiment, the classification 81 of the one or more first modes 72 is based on a convolutional neural network (CNN).

According to an embodiment, the one or more second modes 74 involve the second in-loop filter assigning 81 a further classification 83 to pre-reconstructed samples 12″ of the current picture and filtering 85 the pre-reconstructed samples with a filter transfer function which is adapted to the further classification 83.

According to an embodiment, the classification 81 of the one or more second modes 74 is a hard-classification.

According to an embodiment, the classification 81 of the one or more second modes 74 is CNN based.

According to an embodiment, the one or more first modes 72 are CNN based and/or the second one or more second modes 74 are non-CNN based.

According to an embodiment, the classification 81 of the one or more second modes 74 is based on an analysis of local activity and directionality.

According to an embodiment, the second in-loop filter 66 is configured to perform the adaptive in-loop filtering by use of FIR filters adapted in a sample-wise manner.

For example, as already mentioned, the first modes 72 and/or second modes 74 may perform a sample-wise classification of the pre-reconstructed samples 12″, and the second in-loop filter 66 may use FIR filters for filtering the samples, the FIR filters being adapted for the filtering of the individual samples according to the classification of the respective samples.

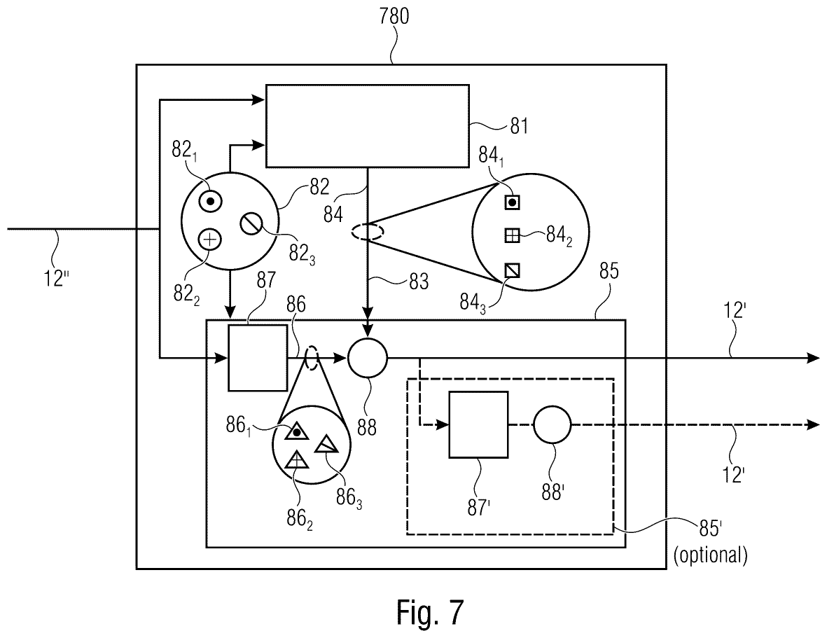

FIG. 7 illustrates a filtering module 780 according to an embodiment, which may be an example of filtering module 80. FIG. 7 illustrates a further embodiment of the filtering module 80. The filtering as performed by the filtering module 780 according to FIG. 7 may represent a filtering using a soft-classification, e.g. as it may be performed by the second in-loop filter 66 when using the one or more first modes 72 according to some embodiments.

In other words, the filtering as performed by filtering module 780 according to FIG. 7 may represent a filtering as it may be performed by the second in-loop filter 66 when selecting any of the one or more first modes 72. The first modes 72 may mutually differ, e.g., in the complexity of the classifier 81 and/or in the filter 85.

According to the embodiment of FIG. 7, for classifying one of the pre-reconstructed samples 12″, for which one of the first modes 72 is selected, classifier 81 performs a classification to assign, for each class of a first set of classes 82, a classification value 84. In FIG. 7, for illustrative purpose, the set of classes comprises the three classes 82₁, 82₂, 82₃, for which classifier determines classification values 84₁, 84₂, 84₃. Each of the first set of classes has an associated filter, e.g. a FIR filter. Filter 85 applies, in block 87 of FIG. 7, the respective filters of each of the classes of the first set of classes to the pre-reconstructed sample 12″ to determine, for each of the classes of the first set 82 a respective filter result. In FIG. 7, the respective filter results for the classes 82₁, 82₂, 82₃ are referenced using reference sings 86₁, 86₂, 86₃. For obtaining the reconstructed sample 12′, operator 88 forms a weighed sum of the filter results obtained for the first set 82 of classes according to the classification values. For example, the classification values for the respective classes are used for weighting the respective filter results.

In other words, contributions of multiple classes, namely the filter results obtained by filtering sample 12″ with the filters associated with the classes of the first set, may contribute to the reconstructed sample 12′ according to the embodiment of FIG. 7. Such filtering may be referred to as soft classification, e.g. in contrast to hard classification, which may, in examples refer to a filtering in which one filter function is selected by means of the classifier 81, and in which merely the result of filtering the sample 12″ using the one selected filter function may contribute to the reconstructed sample 12′ obtained from pre-reconstructed sample 12″.

In more general words, according to an embodiment, the one or more first modes 72 involve the second in-loop filter 66 assigning a classification 83 to pre-reconstructed samples 12″ of the current picture and filtering 85 the pre-reconstructed samples 12″ with a filter transfer function which is adapted to the classification 83, the classification of the one or more first modes 74 being a soft-classification, wherein the second in-loop filter 66 is configured to perform the soft classification for first pre-reconstructed samples (e.g. those for which soft classification, i.e. any first mode, is to be used) by assigning 81, for each first pre-reconstructed sample, a classification value 84 to each of a first set of classes 82, with each of which an associated FIR filter is associated, and performing the adaptive in-loop filtering, in case of using the soft classification for the assigning the classification, by, at each first pre-reconstructed sample, applying, for each class of the first set of classes, the associated FIR filter associated with the respective class to the pre-reconstructed samples to obtain a filter result, and forming a weighted sum of the filter results of the first set of classes according to the classification values.

According to an embodiment, the one or more first modes involve the second in-loop filter assigning a classification to pre-reconstructed samples of the current picture and filtering the pre-reconstructed samples with a filter transfer function which is adapted to the classification, the one or more second modes involve the second in-loop filter assigning a further classification to pre-reconstructed samples of the current picture and filtering the pre-reconstructed samples with a filter transfer function which is adapted to the further classification, the classification of the one or more first modes is a soft-classification, e.g., as described with respect to FIG. 7, and the classification of the one or more second modes is a hard-classification.

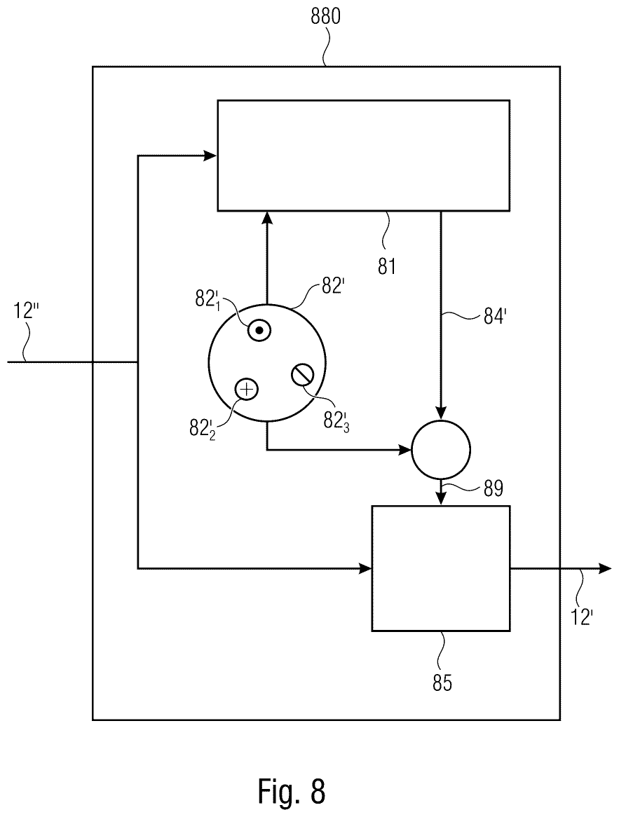

FIG. 8 illustrates a filtering module 880 according to an embodiment, which may be an example of filtering module 80. Filtering module 880 is configured for performing a hard classification, i.e. filtering module 880 may be applied by the second in-loop filter 66 to samples, for which hard-classification is to be applied, e.g. samples, for which one of the second modes 74 is selected. Instead of assigning classification values 84 for each of a set of classes to the current pre-reconstructed sample 12″, as described with respect to FIG. 7, classifier 81 of filtering module 880 may determine a classification index 84′ for the current pre-reconstructed sample, which index points into a set of classes 82′, which may be referred to as second set of classes, as it may differ from the above-introduced first set of classes 82. In FIG. 8, set 82′ is exemplarily represented by classes 82₁′, 82₂′, and 82₃′. Filter 85 may apply filter 89, e.g. a FIR filter, associated with the class, to which the classification index 84′ points, to the current pre-reconstructed sample 12″ to obtain the reconstructed sample 12′.

For example, the second in-loop filter 66 may determine the classification index based on a local activity and directionality information assigned to the current pre-reconstructed sample 12″. E.g., the assignment of the local activity and directionality information assigned to the current pre-reconstructed sample 12″ may be performed by the second in-loop filter 66, e.g. by the filtering module 80, in case that one of the second modes 74 is used.

In more general words, according to an embodiment, the second in-loop filter 66 performs the hard classification for second pre-reconstructed samples (e.g. those for which hard classification, i.e. any of the second modes, is to be used) by assigning a local activity and directionality information to each second pre-reconstructed sample and assigning to each second pre-reconstructed sample a classification index into a second set of classes, with each of which an associated FIR filter is associated, based on the local activity and directionality information assigned to the respective second pre-reconstructed sample, and performing the adaptive in-loop filtering, in case of using the hard classification for the assigning the classification, by applying to the pre-reconstructed samples, at each second pre-reconstructed sample, the associated FIR filter associated with a class of the second set of classes, onto which the classification index points which is assigned to the respective second pre-reconstructed sample.

In the following, further optional details of soft-classification are described. These details may optionally be combined with or implemented in the soft classification as performed by filtering module 780, but the details described with respect to filtering module 780 are optional, i.e. the details described in the following may alternatively refer to soft-classification performed differently.

According to an embodiment, the adaptive in-loop filtering, in case of using the soft classification for the assigning 81 the classification 83, is according to:

$$\hat{y} = y + {\sum }_{k = 1}^{L} {ϕ}_{k} ( y \vert ⊖ ) \cdot ( y * {f}_{k} )$$

wherein ŷ are the samples resulting from the adaptive in-loop filtering; y are pre-reconstructed samples, L is the number of classes in the first set; Φₖ is the classification value for class k and fₖ is the FIR filter associated with class k of the first set.

For example, Θ defines a parametrization of the FIR filter.

According to an embodiment, wherein the adaptive in-loop filtering, in case of using the hard classification for the assigning the classification, is according to:

$$\hat{y} = y + {\sum }_{k = 1}^{L} χ {c}_{k} \cdot ( y * {f}_{k} )$$

wherein ŷ are the samples resulting from the adaptive in-loop filtering; y are pre-reconstructed samples, L is the number of classes in the first set; χ_{C}_{ₖ} is a function assigning 1 to each pre-reconstructed sample to which classification index k is assigned, and zero otherwise, and fₖ is the FIR filter associated with class k of the second set.

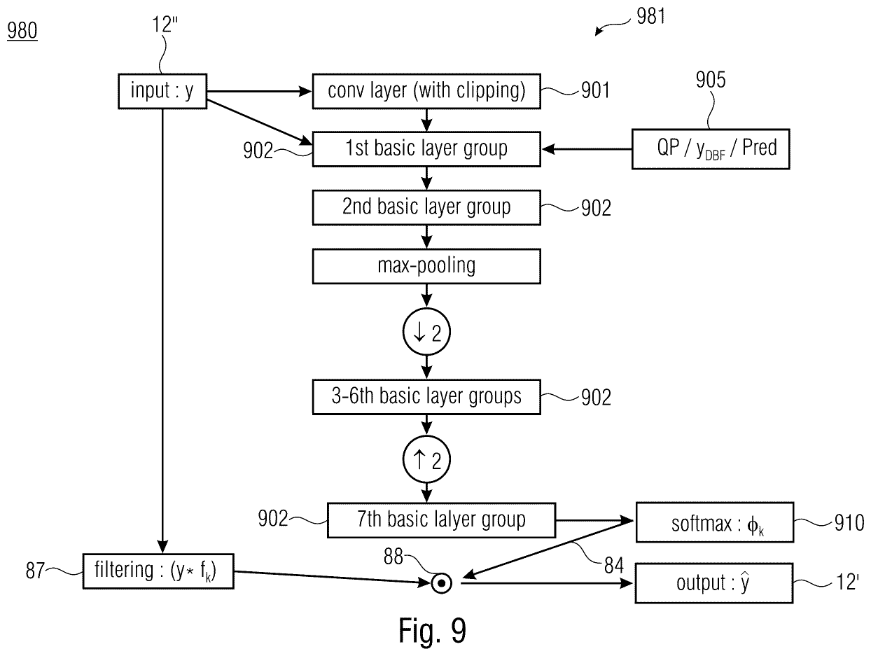

FIG. 9 illustrates a filtering module 980 according to an embodiment, which may optionally correspond to filtering module 80, e.g. to filtering module 780. The filtering as performed by the filtering module 980 may represent a filtering using a soft-classification, e.g. as it may be performed by the second in-loop filter 66 when using the one or more first modes 72 according to some embodiments. According to the embodiment of FIG. 9, the soft classification is implemented at least in parts by a CNN 91 that comprises a convolutional layer 901 and a number of basic layer groups 902. It is noted that the details of the CNN 91 illustrated in FIG. 9 are optional, and that the CNN may be implemented differently in other examples. Further details of FIG. 9 are also optional, and may be combined with using a CNN individually, or in combination with each other. In other words, FIG. 9 illustrates an example for combining several features described in the following, however, these features may be implemented independent from each other and may be integrated to filtering module 80 or filtering module 780 individually or in combination with each other. Correspondences for integrating features of FIG. 9 to the filtering module 80 or filtering module 780 are given by the reference signs.

According to an embodiment, the CNN 91 comprises exactly one convolution layer and exactly 7, 9 or 11 basic layer groups.

According to an embodiment, a structure of the CNN is based on any of the following variants in column “7 layer”, “9 layer” or “11 layer”:

| layer/model | 7 layer | 9 layer | 11 layer | Type |
|---|---|---|---|---|
| clipping | (7, 1, 4) | (3, 1, 4) | (7, 1, 4) | NS |
| 1st BLG | (3, 8, 32) | (3, 8, 32) | (3, 8, 32) | NS |
| 2nd BLG | (3, 32, 64) | (3, 32, 32) | (3, 32, 32) | DS |
| 3rd BLG | (3, 64, 64) | (3, 32, 64) | (3, 32, 64) | DS |
| 4th BLG | (3, 64, 64) | (3, 64, 64) | (3, 64, 64) | DS |
| 5th BLG | (3, 64, 128) | (3, 64, 64) | (3, 64, 64) | DS |
| 6th BLG | (3, 128, 25) | (3, 64, 64) | (3, 64, 64) | DS |
| 7th BLG | (3, 25, 25) | (3, 64, 40) | (3, 64, 64) | DS |
| 8th BLG | | (3, 40, 25) | (3, 64, 64) | DS |
| 9th BLG | | (3, 25, 25) | (3, 64, 64) | DS |
| 10th BLG | | | (3, 64, 25) | DS |
| 11th BLG | | | (3, 25, 25) | DS |

wherein (K, Nᵢₙ, Nₒᵤₜ) refers to kernel size K, a number of input channels Nᵢₙ and a number of output channels Nₒᵤₜ; wherein a type of the layer indicates a type of convolution as non-separable, NS; or depth-wise separable, DS.

According to an embodiment, Θ of the above formula defines the weights of at least one, of some or all layers of a CNN, e.g. CNN 981, used for the assigning of the classification value to each class of the first set 82 or the second set 82′.

According to an embodiment, the classification 81, when using soft-classification, e.g. as described with respect to FIG. 7, is implemented by convolution, batch-normalizing, and a ReLU (rectifying linear unit) activation function.

According to an embodiment, classifier 81 performs soft classification, e.g. as described with respect to FIG. 7, by use of a CNN that is adapted to use at least one of (see input 905 of FIG. 9):
a quantization parameter, QP, information, e.g., a QP parameter, assigned to the current picture;
a reconstructed version 12′ of the current picture inbound to the first in-loop filter 64 (e.g. which comprises a deblocking filter, DBF, or a DBF followed by SAO filter); and
a prediction signal 26 of the current frame (e.g. predicted samples without prediction residual applied thereonto).

According to an embodiment, a 1^{st} basic layer group of a CNN of the soft classification is adapted to receive 8 input channels, advantageously exactly 8 input channels.

According to an embodiment, the 8 input channels comprise:
a quantization parameter, QP, information, e.g., a QP parameter, assigned to the current picture;
a reconstructed version of the current picture inbound to the first in-loop filter (e.g. which comprises a deblocking filter, DBF, or a DBF followed by SAO filter); and
a prediction signal of the current frame (e.g. predicted samples without prediction residual applied thereonto).
four output channels of a convolutional layer preceding and connected to the 1^{st} basic layer group; and
the pre-reconstructed samples.

According to an embodiment, the soft classification is to identify dominant features around a sample location.

According to an embodiment, the soft classification comprises a subsampler for providing a subsampling operator.

According to an embodiment, for implementing the subsampling operator, the soft classification comprises a CNN that comprises a max pooling operator with 3×3 window followed by a 2DN downsampling with factor 2 that is applied to output channels of a second basic layer group of the CNN; wherein in a last layer of the CNN, the downsampling step is reverted by an upsampling with trained upsampling filters.

According to an embodiment, he soft classification is configured for a depth-wise separable convolution.

According to an embodiment, the depth-wise separable convolution comprises a filtering process in two parts; wherein a first part comprises a 2D convolution with a k₁×k₂ kernel that is performed independently over each input channel of the soft classification; wherein a second part comprises a full convolution but with 1×1 kernels that is applied across all channels.

According to an embodiment, the soft classification is adapted for applying a softmax function 910 to an output channel of a last, e.g. seventh, basic layer group of the soft classification.

According to an embodiment, the softmax function 910 comprises a structure based on

$${ϕ}_{k} ( i ) = \frac{exp ( {ψ}_{k} ( i ) )}{{\sum }_{ℓ = 1}^{L} exp ( {ψ}_{ℓ} ( i ) )} for i ∈ I .$$

wherein Φₖ(i) is interpretable as an estimated probability that the corresponding sample location i∈I is associated with a class of index k; Φₖ is a classification output; and ψₗ are the output channels of the last basic layer group.

According to an embodiment, the ALF is adapted for applying multiple 2D filters (fₖ) for different classes k to the classified samples.

According to an embodiment, the ALF is adapted for filtering the classified samples with a clipping function to reduce the impact of neighbour sample values when they are too different with the current sample value being filtered.

According to an embodiment, the clipping function is based on the determination rule

$${\sum }_{i \neq ( 0 , 0 )} f ( i ) Clip ( y ( x + i ) - y ( x ) , ρ ( i ) )$$

to modify the filtering of the input signal y with a 2D-filter f at sample local x wherein ‘Clip’ is the clipping function defined by Clip(d; b)=min(b; max(−b; d)) and ρ(i) are trained clipping parameters used for the filtering process y*fₖ and for a first convolutional layer of a CNN of the soft classification.

According to an embodiment, coefficients of the FIR filters associated with the classes 82 of the first set of classes are received as part of the bitstream 14.

According to an embodiment, the FIR filters associated with the classes of the first set 82 and the second set 82′ of classes comprise a diamond shape.

In the following, referring to FIG. 5, further details of the mode switching 68 are described, which may optionally be combined with any of the details described above with respect to FIGS. 6 to 8.

According to an embodiment, referring to FIG. 5, the mode switch 68 performs the mode switching in units of one or more of
coding treeroot blocks into which the current picture is pre-subdivided in rows and columns of coding treeroot blocks, and from which onwards the picture is subdivided into coding blocks (e.g. in units of which a intra/inter prediction decision is made) by recursive multi-tree partitioning of the coding treeroot blocks,
coding blocks into which the current picture is subdivided by pre-subdividing the current picture into coding treeroot blocks in rows and columns of coding treeroot blocks, and subdividing the picture further from the coding treeroot blocks onwards by recursive multi-tree partitioning g of the coding treeroot blocks, and
slices of the current picture. For example, each picture may be encoded and decoded in units of slices, into which the pictures are subdivided.

According to an embodiment, decoder 20 performs the mode switching by use of a syntax element in the bitstream.

According to an embodiment, the syntax element is signalled in the bitstream 14 individually for
coding treeroot blocks into which the current picture is pre-subdivided in rows and columns of coding treeroot blocks, and from which onwards the picture is subdivided into coding blocks (e.g. in units of which a intra/inter prediction decision is made) by recursive multi-tree partitioning of the coding treeroot blocks,
coding blocks into which the current picture is subdivided by pre-subdividing the current picture into coding treeroot blocks in rows and columns of coding treeroot blocks, and subdividing the picture further from the coding treeroot blocks onwards by recursive multi-tree partitioning g of the coding treeroot blocks, and
slices of the current picture.

According to an embodiment, the second in-loop filter 66 performs the mode switching 68 by estimating a measure of complexity incurred by the second in-loop filter 66 or the one or more first modes 72 of the second in-loop filter within a predetermined video or picture section so far (e.g. number of multiplications per sample; e.g. by assuming a pre-set worst-case number of multiplications to be incurred each time the soft-classification is performed). The second in-loop filter 66 may check whether the estimation fulfills a predetermined criterion (e.g. exceeds a threshold), and if so, inferring that the syntax element, if same relates to (e.g. a block within . . . ) the predetermined video or picture section, assumes a predetermined value not corresponding to any first mode (e.g. “any of, i.e. each of, the one or more first modes”), or any first mode exceeding a predetermined complexity.

Alternatively, if the estimation fulfills the predetermined criterion estimation, the second in-loop filter 66 may infer that the syntax element, if same relates to (e.g. a block within . . . ) the predetermined video or picture section has a decreased value domain which excludes the one or more first modes, or any first mode (i.e. all those) exceeding the predetermined complexity, and is decreased relative to a complete value domain the syntax element has outside the predetermined video or picture section (e.g. if, or for sections for which, the even further predetermined criterion is not fulfilled), so that a bit rate for signaling at least one value in the decreased value domain, which does not correspond to any first mode, or any first mode exceeding the predetermined complexity, has a smaller bitrate consumption than compared to a corresponding value in the complete value domain (e.g. when using a truncated unary code).

According to an embodiment, the second in-loop filter 66 performs the mode switching 68 (e.g. inter alias) based on an estimation of a measure of complexity (e.g. number of multiplications per sample) incurred by the second in-loop filter or the one or more first modes of the second in-loop filter within a predetermined video or picture section so far by disabling the one or more first modes, or any first mode (i.e. all those) exceeding a predetermined complexity for the predetermined video or picture section if the estimation fulfills a predetermined criterion (e.g. exceeds a threshold).

According to an embodiment, the second in-loop filter 66 performs the mode switching 68 by determining, within a predetermined picture area, a measure for prediction quality or prediction imperfection within the predetermined picture area. The second in-loop filter 66 may check, whether the measure for prediction or prediction imperfection fulfills a further predetermined criterion (e.g. indicates that the prediction is poorer than a threshold), and if so, the second in-loop filter 66 may infer that the syntax element, if same relates to (e.g. a block within . . . ) the predetermined picture area, assumes a predetermined value not corresponding to any first mode, or any first mode exceeding a predetermined complexity. Alternatively, if the estimation fulfills the predetermined criterion estimation, the second in-loop filter 66 may infer that the syntax element, if same relates to (e.g. a block within . . . ) the predetermined video or picture section has a decreased value domain which excludes the one or more first modes, or any first mode exceeding the predetermined complexity, and is decreased relative to a complete value domain the syntax element has outside the predetermined picture area (e.g. if, or for areas for which, the even further predetermined criterion is not fulfilled), so that a bit rate for signaling at least one value in the decreased value domain, which does not correspond to any first mode, or any first mode exceeding the predetermined complexity, has a smaller bitrate consumption than compared to a corresponding value in the complete value domain (e.g. when using a truncated unary code).

According to an embodiment, the second in-loop filter 66 performs the mode switching 68 (e.g. inter alias) based on prediction type or inter-prediction hierarchy level of a picture by disabling the one or more first modes, or any first mode exceeding a predetermined complexity for the picture if the measure for prediction quality or prediction imperfection fulfills a even further predetermined criterion.

According to an embodiment, the measure for prediction quality or prediction imperfection includes one or more of
the prediction residual being zero within the predetermined picture area,
the areal fraction in which the prediction residual is zero,
a number of coded non-zero transform coefficients,
an energy of coded transform coefficients.

According to an embodiment, the predetermined picture area is a coding treeroot block, coding block, or slice.

According to an embodiment, the second in-loop filter 66 performs the mode-switching 68 by determining a prediction type or inter-prediction hierarchy level of a picture. The second in-loop filter 66 may check whether the prediction type or inter-prediction hierarchy level fulfils an even further predetermined criterion, and if so, inferring that the syntax element, if same relates to (e.g. a block within . . . ) the picture assumes a predetermined value not corresponding to any first mode, or any first mode exceeding a predetermined complexity. Alternatively, if the prediction type or inter-prediction hierarchy level fulfils the even further predetermined criterion, the second in-loop filter 66 may infer that the syntax element, if same relates to (e.g. a block within . . . ) the picture has a decreased value domain which excludes the one or more first modes, or any first mode exceeding (whose complexity exceeds) a predetermined complexity, and is decreased relative to a complete value domain the syntax element has outside the picture (e.g. if, or for pictures for which, the even further predetermined criterion is not fulfilled), so that a bit rate for signaling at least one value in the decreased value domain, which does not correspond to any first mode, or any first mode exceeding the predetermined complexity, has a smaller bitrate consumption than compared to a corresponding value in the complete value domain (e.g. when using a truncated unary code).

According to an embodiment, the second in-loop filter 66 performs the mode switching 68 (e.g. inter alias) based on prediction type or inter-prediction hierarchy level of a picture by disabling the one or more first modes, or any first mode exceeding a predetermined complexity for the picture if the measure for prediction quality or prediction imperfection fulfills a even further predetermined criterion.

According to an embodiment, the prediction type indicates whether the picture is inter-predicted based on reference pictures preceding and succeeding the picture in presentation time order, with the even further predetermined criterion being fulfilled if this is the case, and/or the inter-prediction hierarchy level of a picture indicates a temporal hierarchy level of the picture in a GOP, with the even further predetermined criterion being fulfilled if the hierarchy level exceeds same threshold.

According to an embodiment, the second in-loop filter 66 performs the mode switching 68 by checking whether a predetermined picture portion has at least one reference picture which succeeds a picture of the predetermined picture portion in presentation time order, and if so, inferring that the syntax element, if same relates to the predetermined picture portion assumes a predetermined value not corresponding to any first mode, or any first mode exceeding a predetermined complexity. Alternatively, if the predetermined picture portion has at least one reference picture which succeeds a picture of the predetermined picture portion in presentation time order, the second in-loop filter 66 may infer, that the syntax element, if same relates to the predetermined picture portion has a decreased value domain which excludes the one or more first modes, or any first mode exceeding a predetermined complexity, and is decreased relative to a complete value domain the syntax element has outside the predetermined picture portion (e.g. if, or for picture portions for which, the even further predetermined criterion is not fulfilled), so that a bit rate for signaling at least one value in the decreased value domain, which does not correspond to any first mode, or any first mode exceeding the predetermined complexity, has a smaller bitrate consumption than compared to a corresponding value in the complete value domain (e.g. when using a truncated unary code).

According to an embodiment, the second in-loop filter 66 performs the mode switching 68 (e.g. inter alias) in dependence on whether for a predetermined picture portion at least one reference picture succeeds a picture of the predetermined picture portion in presentation time order by disabling the one or more first modes, or any first mode exceeding the predetermined complexity for the predetermined picture portion if this is the case.

According to an embodiment, the predetermined picture portion is a slice or a whole picture.

According to an embodiment, the second in-loop filter 66 performs the mode switching 68 by checking whether a further predetermined picture portion is, within at least one block, or completely intra coded, and if so, the second in-loop filter 66 may infer that the syntax element, if same relates to the further predetermined picture portion, assumes a predetermined value not corresponding to any first mode, or any first mode exceeding a predetermined complexity. Alternatively, if the further predetermined picture portion is, within at least one block, or completely intra coded, the second in-loop filter 66 may infer that the syntax element, if same relates to the further predetermined picture portion, has a decreased value domain which excludes each first mode, or any first mode exceeding a predetermined complexity, and is decreased relative to a complete value domain the syntax element has outside the further predetermined picture portion (e.g. if, or for further picture portions for which, the even further predetermined criterion is not fulfilled), so that a bit rate for signaling at least one value in the decreased value domain, which does not correspond to any first mode, or any first mode exceeding the predetermined complexity, has a smaller bitrate consumption than compared to a corresponding value in the complete value domain (e.g. when using a truncated unary code).

According to an embodiment, the second in-loop filter 66 performs the mode switching 68 the mode switching (e.g. inter alias) in dependence on whether a further predetermined picture portion is, within at least one block, or completely intra coded by disabling the one or more first modes, or any first mode exceeding a predetermined complexity for the further predetermined picture portion if this is the case.

According to an embodiment, the predetermined picture portion is a slice, a whole picture or a CTU or a CU.

According to an embodiment, the soft classification is adapted to provide for a number of at most 35000, e.g., 29873, trained parameters.

In the following, referring to FIG. 7, an alternative implementation of filtering module 780 is described. According to this embodiment, each of the first set of classes 82 has a first FIR filter and a second FIR filter is associated therewith. According to this alternative embodiment, filter 85 comprises a further filtering stage 85′, which is illustrated in FIG. 7 as an optional implementation. According to this embodiment, operator 88 may merely perform a weighting of filter results 86 using the respective classification values 84, but operator 88 does not necessarily perform a summation of the weighted filter results. Instead, the weighted filter results may be input to the further filtering module 87′, which subjects the weighted filter results to the respective second FIR filters associated with their respective classes, e.g. as described with respect to equation (4) below. E.g., operator 88 may weight the filter result 86₁ using the classification value 84₁ and the resulting weighed filter result may be subjected to the second FIR filter associated with class 82₁ by the further filtering module 87′. A further operator 88′, e.g. a combiner, may combine, e.g. sum up, the filter results provided by the further filtering module 87′ to provide the reconstructed sample 12′.

In more general words, according to an embodiment, each of the first set of classes 82 has a first FIR filter and a second FIR filter is associated therewith, and the second in-loop filter 66 performs the soft classification for first pre-reconstructed samples 12″ (e.g. those for which soft classification is to be used) by assigning 81, for each first pre-reconstructed sample, a classification value 84 to each of the first set of classes 82. According to this embodiment, the second in-loop filter 66 performs the adaptive in-loop filtering, in case of using the soft classification for the assigning the classification, by applying 87, for each class of the first set of classes 82, the associated first FIR filter associated with the respective class onto the pre-reconstructed samples 12″ to obtain a first filtered version, e.g. filter results 86 in FIG. 7. The second in-loop filter 66 may weight, see e.g., operator 88, for each class of the first set of classes, the first filtered version 86 at each sample position with the classification value 84 assigned to the respective class for the first pre-reconstructed sample at the respective sample position to obtain a second filtered version. According to this embodiment, the second in-loop filter 66 applies, for each class of the first set of classes 82, the associated second FIR filter associated with the respective class onto the second filtered version, see, e.g., further filtering module 87′, to obtain a third filtered version, and subjects, for each second pre-filtered version, the third filtered version obtained for the classes of the first set, to a summation, e.g., operator 88′. For example, for each class of the first set of classes 82 coefficients, and/or a size and/or shape of a kernel of the second FIR filter are conveyed in the bitstream.

According to an embodiment, the second in-loop filter 66 switches, based on the bitstream 14, between the two alternatives of performing the soft-classification described with respect to FIG. 7, namely a first manner, in which operator 88 performs a summation to provide the reconstructed samples 12′, and a second manner, making use of the optional further filtering module 85′.

In other words, according to an embodiment, the second in-loop filter 66 switches, based on the bitstream 14, between
performing the soft classification for first pre-reconstructed samples (e.g. those for which soft classification is to be used) in a first manner by assigning, for each first pre-reconstructed sample, a classification value to each of a first set of classes, with each of which an associated FIR filter is associated, and performing the adaptive in-loop filtering, in case of using the soft classification for the assigning the classification, by applying, at each first pre-reconstructed sample, for each class of the first set of classes, the associated FIR filter associated with the respective class to the pre-reconstructed samples to obtain a filter result, and forming a weighted sum of the filter results of the first set of classes according to the classification values; and
performing the soft classification for first pre-reconstructed samples (e.g. those for which soft classification is to be used) in a second manner by assigning, for each first pre-reconstructed sample, a classification value to each of a first set of classes, with each of which an associated first FIR filter and a second filter is associated, and performing the adaptive in-loop filtering, in case of using the soft classification for the assigning the classification, by
   applying, for each class of the first set of classes, the associated first FIR filter associated with the respective class onto the pre-reconstructed samples to obtain a first filtered version,
   weighting, for each class of the first set of classes, the first filtered version at each sample position with the classification value assigned to the respective class for the first pre-reconstructed sample at the respective sample position to obtain an second filtered version,
   applying, for each class of the first set of classes, the associated second FIR filter associated with the respective class onto the second filter version to obtain a third filtered version,
   subjecting, for each second pre-filtered version, the third filtered version obtained for the classes of the first set, to a summation,
   wherein for each class of the first set of classes coefficients, and/or a size and/or shape of a kernel of the second FIR filter are conveyed in the bitstream.

According to an embodiment, the second in-loop filter 66 performs the switching between performing the performing the soft classification for first pre-reconstructed samples in the first or second manner in units of one or more of
coding treeroot blocks into which the current picture is pre-subdivided in rows and columns of coding treeroot blocks, and from which onwards the picture is subdivided into coding blocks (e.g. in units of which a intra/inter prediction decision is made) by recursive multi-tree partitioning of the coding treeroot blocks,
coding blocks into which the current picture is subdivided by pre-subdividing the current picture into coding treeroot blocks in rows and columns of coding treeroot blocks, and subdividing the picture further from the coding treeroot blocks onwards by recursive multi-tree partitioning of the coding treeroot blocks, and
slices of the current picture;
pictures of the video,
a sequence of Pictures of the video,
the video.

According to an embodiment, the second in-loop filter 66 performs the switching between performing the soft classification for first pre-reconstructed samples in the first or second manner (e.g. inter alias) based on an estimation of a measure for multiplications per sample incurred by the second in-loop filter for the current picture so far by disabling the soft classification if the estimation fulfills a predetermined criterion (e.g. exceeds a threshold).

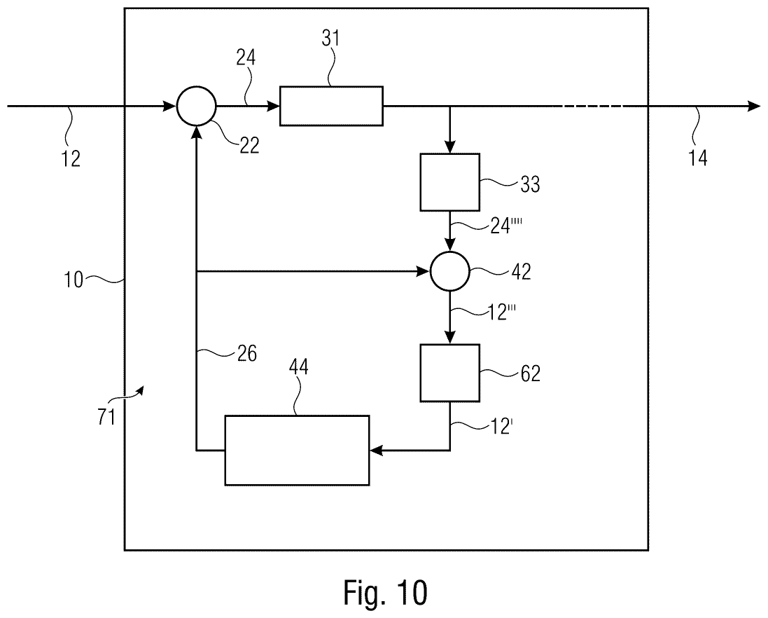

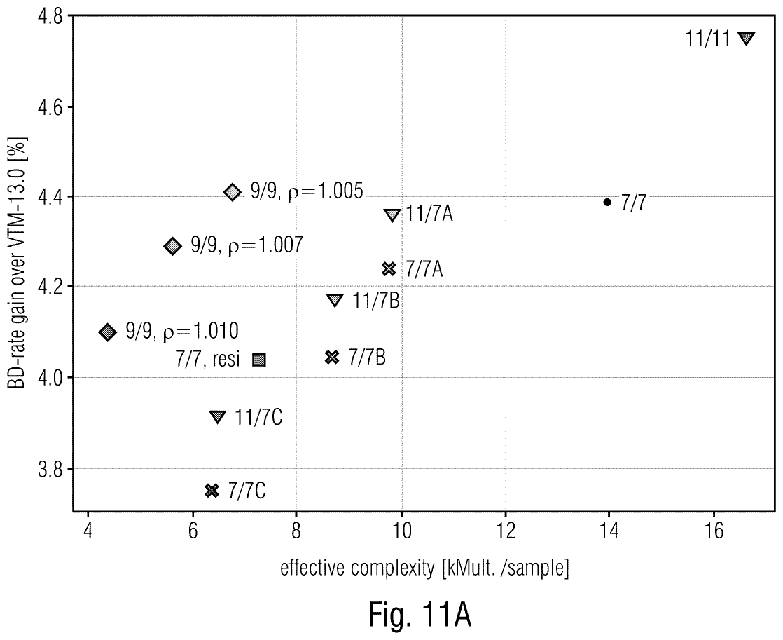

FIG. 10 illustrates an apparatus 10 for encoding a video into a bitstream 14 according to an embodiment. Apparatus 10 may be referred to as encoder 10, and may optionally but not necessarily be implemented like encoder 10 of FIG. 1. Encoder 10 encodes, into the bitstream 14, (e.g. according to H.266) the video using block-based predictive encoding, transform-based residual encoding and a prediction loop 71 into which the in-loop filter tool 62 described with respect to FIG. 4 is serially connected. As described before, the in-loop filter tool 62 comprises a serial connection of a first in-loop filter 64 and a second in-loop filter 66, and the second in-loop filter 66 is configured to subject pre-reconstructed (in the prediction loop) samples 12′″ of a current picture to an adaptive in-loop filtering, ALF, (e.g. whose filter transfer function is locally adapted).

For example, encoder 10 may comprise an encoding module 31 to encode the video signal 12 representing the video. For example, the video signal may represent a sequence of pictures, which may be encoded by encoding module 31 according to a coding order. For example, the prediction loop 71 may be formed in that encoder 10 reconstructs the encoded signal provided by encoding module 31 to derive a reconstructed signal 12′, e.g. signal 46 of FIG. 1, which may be input to a prediction module 44. Prediction module 44 may derive a prediction signal 26, which is used for encoding of a portion of the video signal 12 following the already encoded portion in coding order, e.g. by subtracting the prediction signal 26, using operator 22 to derive a residual signal 24, which is input to the encoding module 31. The portions may be part of (or represent) different pictures, in which case the prediction may be referred to as temporal prediction or inter-prediction, i.e. a reconstructed picture or a portion thereof may be used by prediction module 44 for predicting a picture (or a portion thereof) following the current picture in coding order. Alternatively, the portions may be different blocks of the same picture, in which case the prediction may be referred to as intra-prediction. Prediction loop 71 may also combine different types of prediction. For example, the prediction loop 71 may be implemented as described with respect to FIG. 1, FIG. 2 and FIG. 3.

Further in the description of the prediction loop 71, the prediction signal 26 may be used for predicting a portion of the signal 12 and for reconstructing same portion in the prediction loop 71, see combiner 42. Combiner 42 may combine the residual signal 26 with a reconstructed residual signal 24″″ derived by decoding module 33 from the encoded signal provided by the encoding module 31. For example, decoding module 33 may perform the inverse operation of encoding module 31, e.g., despite coding loss introduced by quantization. For example, encoding module 31 may correspond to transformer 28 and quantizer 32 and decoding module 33 may correspond to dequantizer 38 and inverse transformer 40 of FIG. 1. Combiner 42 may provide a reconstruction of the signal 12, which may differ from the original signal 12 in terms of coding loss. The reconstructed signal provided by combiner 42 may be referred to as pre-reconstructed signal 12′″. This signal may be input to the in-loop filtering tool 62 to derive the reconstructed signal 12′.

It is noted that encoder 10 may comprise entropy coder 34, e.g. as illustrated in FIG. 1, to encode the encoded signal into the bitstream 14.

Insofar, the block-based predictive encoding and the transform-based residual encoding may be performed by encoding stage 31, e.g. in combination with the prediction loop 71, in particular in combination with the prediction module 44. It is noted however, that the implementation of the prediction loop 71 illustrated in FIG. 10 is exemplarily, in particular, the splitting into encoding stage 31 and prediction loop 71, as it is illustrated in FIG. 10, is exemplarily. The prediction loop 71 may also be implemented differently.

The in-loop filtering tool 62 may be implemented as described with respect to FIGS. 4 to 9. Where it is described, with respect to the decoder 20, that information is obtained from the bitstream 14, encoder 14 may encode this information into the bitstream. In examples, the encoder 10 may perform a rate-distortion estimation to derive a decision, e.g. by estimating a rate and/or a distortion measure resulting from a particular coding decision. Encoder may indicate the decision in the bitstream 14.

Further, referring to the embodiments described with respect to decoder 20, if it is described that decoder 10 infers the value of a syntax element, the encoder 10 may treat this syntax element as being required to be inferred by the decode, and therefore may refrain from encoding the syntax element into the bitstream. Encoder 10 may derive the value of the syntax element based on the same measures/criterions as described with respect to the decoder, and may perform the mode switching accordingly.

Some aspects developed above shall be repeated hereinbelow again.

Aspect I (Switching between soft-classification based in-loop filters/conventional ALF/no ALF so that some complexity threshold in terms of average number of multiplications per sample is not exceeded):

One or several types of soft-classification based in-loop filters are supported, which may have different complexity. For each block of samples, at most one of these soft-classification based in-loop filters may be applied or none of them may be applied, where in the latter case, either the Adaptive Loop Filter with hard classification or no additional loop filter may be applied and where the switching between all these configurations (the different soft-classification based in-loop filters and the hard-classification-case/no-loop-filter-case) is always done such that a specific maximal number of multiplications per sample required by the execution of all soft-classification based in-loop filters, measured on average over some unit or sub-portion of the decoded video-sequence, does not exceed a specific threshold.

The switching may be signaled on a block-level. If a maximal threshold in terms of number of multiplications for a given unit or sub-portion has been reached and if a block still belongs to the given unit or sub-portion, it is automatically inferred that no soft-classification based in-loop filter is supported for this block.

Aspect II: (Switching between soft-classification based in-loop filters/conventional ALF/no ALF depends of prediction residual. The ‘more’ residual, the more complex the soft-classification based in-loop filter may be):

At least one soft-classification based in-loop filter+ALF+No-Inloop filter are supported, where the specific supported soft-classification based in-loop filter for a given block or the specific set of soft-classification based in-loop filers supported for the given block or the selection of whether any of the soft-classification based in-loop filters is to be applied at all on the given block depends on whether for the given block or for some sub-block of the given block, a prediction residual is coded in the bit-stream or where this selection depends on some specific quantity derived from the coded prediction residual for the given block or the sub-blocks of it, for example the number of coded non-zero transform coefficients, the energy of the coded transform coefficients etc. . . .

In one specific embodiment, the application of any of the soft-classification based in-loop filters is completely prohibited for the case that for no sub-block of the given block, a prediction residual is coded in the bit-stream. In this case, any configuration flag indicating whether the soft-classification based in-loop filter is to be used at all is inferred at a decoder to be false.

In another specific embodiment, only a soft-classification based in-loop filter that requires a number of multiplications per sample which is strictly smaller than that of some other soft-classification based in-loop filter which is supported on some other blocks is supported for blocks which have the property that for no sub-block of them, a prediction residual was coded in the bit-stream.

Aspect III: (Switching between soft-classification based in-loop filters/conventional ALF/no ALF depends on position of frame in the hierarchy between frames used for inter-prediction. Blocks on no-key frames may not use soft-classification based in-loop filters. Blocks on key-frames may use the most complex soft-classification based in-loop filters. Here, key frames are characterized as those frames which may refer only to past but not to future frames in output order.):

At least one soft-classification based in-loop filter+ALF+No-Inloop filter are supported, where the specific supported soft-classification based in-loop filter for a given block or the specific set of soft-classification based in-loop filers supported for the given block or the selection of whether any of the soft-classification based in-loop filters is to be applied at all on the given block depends on whether for the given frame/slice etc. that the block belongs to, reference samples for inter-prediction are available that belong to other frames/slices etc. which in the temporal-output order of the sequence lie in the future of the given frame/slice etc. that the block belongs to.

In one specific embodiment, the application of any of the soft-classification based in-loop filters is completely prohibited for the case that for the given frame/slice etc. that the given block belongs to, reference samples for inter-prediction are available that belong to other frames/slices etc. which in the temporal-output order of the sequence lie in the future of the given frame/slice etc. that the block belongs to.

In another specific embodiment, only soft-classification based in-loop filters that require a number of multiplications per sample which is strictly smaller than that of some other soft-classification based in-loop filters which are supported on some other blocks are supported for blocks which have the property that for the frame/slice that they belong to, reference samples for inter-prediction are available that belong to other frames/slices which in the temporal-output order of the sequence lie in the future of the given frame/slice that the block belongs to.

Aspect IV (Switching between soft-classification based in-loop filters/conventional ALF/no ALF depends on whether intra-coded blocks are present or whether whole block is intra-coded. The ‘more intra’, the more complex the soft-classification based in-loop filter may be):

At least one soft-classification based in-loop filter+ALF+No-Inloop filter are supported, where the specific supported soft-classification based in-loop filter for a given block or the specific set of soft-classification based in-loop filers supported for the given block or the selection of whether any of the soft-classification based in-loop filters is to be applied at all on the given block depends on the number of intra-predicted sample in the given block.

In a specific embodiment, only soft-classification based in-loop filters that require a number of multiplications per sample which is strictly smaller than that of some other soft-classification based in-loop filters which are supported on some other blocks are supported for blocks which have the property that for none of their sub-blocks, intra-prediction was applied.

In the following a performance-complexity analysis of an adaptive loop filter is described, and based thereon, embodiments for video encoders/decoders are derived and described. The features of the embodiments described in the following may be combined with any of the embodiments described with respect to FIGS. 1 to 10. Equivalently, functionalities and advantages of the features described below may also be applicable to corresponding features (or similar features such as generalizations of the features described below) of the embodiments described with respect to FIGS. 1 to 10.

According to embodiments, the ALF may use CNN-based Classification.

According to an embodiment, the signal-modification is generated by a weighted sum of FIR-filterings. The weights may vary per sample and are computed by an offline-trained CNN. They can be interpreted as probabilities for a sample to belong to a specific class.

Convolutional neural network (CNN)-based in-loop filters are used for video coding and show great potential. However, one of the main issues of this approach is the high computational complexity of these filters. In the following, we present various settings for CNN-based in-loop filters targeting on the reduction of their decoder-complexity and describe the corresponding gain-complexity trade-offs. To this end, an effective complexity measure is used. Experiments show that it is possible to notably reduce this value for some CNN-based in-loop filters while maintaining similar average BD-rate savings, e.g., over Versatile Video Coding (VVC).

The following part of the description is structured as follows. Firstly, an embodiment of an ALF algorithm and a CNN-based in-loop filter as introduced in [11] is described. Thereafter, various variants of the CNN-based in-loop filter providing a further reduction of its complexity are described. Finally, simulation results are shown.

In the following, an embodiment of an CNN based in-loop filter is described, as it may optionally be implemented by the second in-loop filter 66. ALF partitions the reconstructed samples y into L=25 classes Cₖ. The samples of each such class are filtered with an FIR filter fₖ. Thus, ALF generates the reconstructed filtered frame ŷ according to

$$\hat{y} = y + {\sum }_{k = 1}^{L} {χ}_{{C}_{k}} \cdot ( y * {f}_{k} ) . \qquad ( 1 )$$

Here, χ_{C}_{ₖ} is the characteristic function of Cₖ defined by

$$χ {c}_{k} ( i ) = ( \begin{matrix}1 & i ∈ {C}_{k} \\ 0 & i ∉ {C}_{k}\end{matrix} for i ∈ I ,$$

where I denotes the set of all sample locations.

In the following, an embodiment is described with respect to FIG. 9. The embodiment described in the following is independent of the features described with respect to FIG. 9 above, but features described in the following may optionally be combined with any of the embodiments described before. In FIGS. 9, ↓2 and ↑2 may be the 2D down/upsampling operators and ⊙ the sum of elementwise products between classification outputs ϕₖ and filtering outputs (y*fₖ).

A natural extension of (1) where the ALF classification χ_{C}_{ₖ} is replaced by CNN-based classifier has been proposed in [11] and is defined by

$$\hat{y} = y + {\sum }_{k = 1}^{L} {ϕ}_{k} ( y \vert Θ ) \cdot ( y * {f}_{k} ) . \qquad ( 2 )$$

Here, ϕ₁, . . . , ϕ_{L} denote the classification outputs of a trained CNN-based classifier with trained parameters Θ and fₖ denote FIR-filters that are also determined during training. The process (2) can be seen as an extension of (1) where the ALF classification functions are replaced by more general classification functions ϕₖ. The model architecture of the CNN-based classifier ϕₖ(y|Θ) is described with respect to in FIG. 9 and Table 1. It consists of 7 basic layer groups (BLG) where a convolutional layer (Conv), a batch-normalization (BN) [14] and the rectified linear (ReLU) activation function [15] are applied consecutively in each such group. In addition to the input frame y, a QP-parameter plane QP (a constant input plane filled with the normalized QP values), the reconstructed frame before deblocking y_{DBF} and the prediction signal Pred are fed as an input to the first BLG. The final step of the CNN classifier is to apply the softmax function [16] to generate the classification outputs ϕ₁, . . . , ϕ_{L}. For each BLG, the second column of Table 1 shows the convolution kernel size K as well as the numbers of input and output channels Nᵢₙ and Nₒᵤₜ of the form (K, Nᵢₙ, Nₒᵤₜ) along with convolution type, nonseparable (NS) and depth-wise separable (DS) [17]. We note that the filtering process (y*fₖ) is replaced by the non-linear filtering operation

$${\sum }_{i} f ( i ) \cdot Clip ( ρ ( i ) ( y ( j + i ) - y ( j ) ) , 1 ) , \qquad ( 3 )$$

where j is the output sample location, i denotes the sample locations in the support of f and ρ(i) are trained parameters. Here, Clip is the clipping function defined by Clip(d, b)=min(b, max(−b, d)). For notational simplicity, we shall denote the 2D-convolution including the clipping still by y*fₖ. A similar clipping operation is also applied for the first convolutional layer of the classifier, as displayed in FIG. 9.

Finally, in order to better adapt to specific signal characteristics, according to an embodiment, an additional filtering process is used, now with adaptive filters \tilde{f}ₖ that are transmitted in the bit-stream and are optimized at the encoder for each input frame. This additional 2nd filtering step is performed after filtering with the fₖ and is defined as

$$\hat{y} = y + {\sum }_{k = 1}^{L} {\tilde{f}}_{k} * ( {ϕ}_{k} ( y \vert Θ ) \cdot ( y * {f}_{k} ) ) . \qquad ( 4 )$$

Here, the filters \tilde{f}ₖ are computed such that the mean squared error between the target frame and the filtered reconstructed frame is minimized. We refer to [11] for a more detailed description of the CNN-based in-loop filter defined in (2) and (4).

In the following, CNN-based In-Loop Filters with various complexities according to embodiments are described, which may be variants of the CNN-based in-loop filter discussed above with respect to equations (2) to (4), and which may optionally be embodiments of the second in-loop filter 66. For example, all of the following embodiments may share the same basic structure consisting of a CNN-based classifier ϕₖ and the filtering process (y*fₖ) as described in (2). All variants are generated from the original 7-layer model presented in [11] and discussed above by modifying the number of channels for some of the BLGs, adding some further BLGs or introducing skip connections [18] between some of the BLGs. Here, a skip connection between the i-th and the j BLG is realized by adding the i-th BLG's input to output of the (j−1)-th BLG's activation sub-layer and using the result as the input for the j-th layer. Note that, like the original 7-layer model, all variants make use of the additional input data, QP, y_{DBF} and Pred which are fed as inputs to the first BLG. Furthermore, also like the original 7-layer model, all variants may optionally share the maximum pooling operation with a 3×3 window followed by a downsampling by a factor of two which is applied to the second BLG's output. For all variants, this subsampling may optionally be reverted by an upsampling step with trained interpolation filters in the last BLG which is again identical to the original 7-layer architecture.

Exemplary embodiments, to which the experiments discussed below refer, include the following:
7-layer model: the model presented in [11] and discussed above (see Table 1)
7-layer-(A, B, C) model: 7-layer models modified by the reducing the numbers of output channels for multiple selections of BLGs (see Table 2)
9-layer model: 9-layer model with a single skip connection between the 3rd and the 6th BLGs (see Table 1)
11-layer model: 11-layer model with skip connections between i-th and i+1-th BLGs for i∈{2, 3, 4, 5, 6, 7, 8} (see Table 1)

The total worst-case number of multiplications per luma-pixel for (2) associated with each of the models is illustrated in Table 3. These values can easily be derived from the model architectures given by Tables 1-2. We refer to [11] for more details about this.

TABLE 1
Architectures of the CNN-based classifiers

| layer/model | 7 layer | 9 layer | 11 layer | Type |
|---|---|---|---|---|
| clipping | (7, 1, 4) | (3, 1, 4) | (7, 1, 4) | NS |
| 1st BLG | (3, 8, 32) | (3, 8, 32) | (3, 8, 32) | NS |
| 2nd BLG | (3, 32, 64) | (3, 32, 32) | (3, 32, 64) | DS |
| 3rd BLG | (3, 64, 64) | (3, 32, 64) | (3, 64, 64) | DS |
| 4th BLG | (3, 64, 64) | (3, 64, 64) | (3, 64, 64) | DS |
| 5th BLG | (3, 64, 128) | (3, 64, 64) | (3, 64, 64) | DS |
| 6th BLG | (3, 128, 25) | (3, 64, 64) | (3, 64, 64) | DS |
| 7th BLG | (3, 25, 25) | (3, 64, 40) | (3, 64, 64) | DS |
| 8th BLG | | (3, 40, 25) | (3, 64, 64) | DS |
| 9th BLG | | (3, 25, 25) | (3, 64, 64) | DS |
| 10th BLG | | | (3, 64, 25) | DS |
| 11th BLG | | | (3, 25, 25) | DS |

TABLE 2
Architectures of CNN-based classifiers with low complexity

| Layer | 7 layer-A | 7 layer-B | 7 layer-C | Type |
|---|---|---|---|---|
| clipping | (7, 1, 4) | (7, 1, 4) | (7, 1, 4) | NS |
| 1st BLG | (3, 8, 16) | (3, 8, 16) | (3, 8, 16) | NS |
| 2nd BLG | (3, 16, 64) | (3, 16, 32) | (3, 16, 32) | DS |
| 3rd BLG | (3, 64, 64) | (3, 32, 64) | (3, 32, 32) | DS |
| 4th BLG | (3, 64, 64) | (3, 64, 64) | (3, 32, 32) | DS |
| 5th BLG | (3, 64, 64) | (3, 64, 64) | (3, 32, 32) | DS |
| 6th BLG | (3, 64, 25) | (3, 64, 25) | (3, 32, 25) | DS |
| 7th BLG | (3, 25, 25) | (3, 25, 25) | (3, 25, 25) | DS |

TABLE 3
Number of multiplications per luma-pixel and number
of parameters for CNN-based in-loop filters

| model | complexity (k mul/sample) | # of para |
|---|---|---|
| 7 layer model | 15.9 | 29844 |
| 7 layer-A model | 11.0k | 22484 |
| 7 layer-B model | 9.6k | 19124 |
| 7 layer-C model | 6.8k | 11380 |
| 9 layer model | 15.9k | 30404 |
| 11 layer model | 19.9k | 42324 |

According to embodiments, a residual-based criterion for CNN-based in-loop filter is applied. One of the main targets of the proposed CNN-based in-loop filters is the reduction of the error introduced by inaccurate prediction signals and quantization noise in the reconstructed transform coefficients. Embodiments of the invention rely on the finding that it seems a valid assumption to expect the filters to only have minor effect for blocks where the prediction is accurate enough, i.e. where the prediction residual is zero. As this is often the case, especially for the deeper temporal levels of inter prediction, there are numerous blocks where one can expect the effect of the in-loop filters on the coding gain to be relatively small compared to the complexity overhead introduced by the CNNs. Therefore, one approach provided by embodiments is to improve the trade-off by disallowing the CNN-based in-loop filters for all input blocks where the quantized prediction residual is zero. This approach can be applied to any of the above-described CNN-based in-loop filter architectures. However, in order to show the effect of the residual-based criterion, we chose the 7-layer model described above and Table 1 for the experiments presented below. Additional to the residual-based restrictions during the inference, in embodiments, the training of the CNN was also slightly modified compared to the 7-layer model described above. In particular, all samples where the quantized prediction residual was zero were excluded from the training loss in order to put the focus on the samples with non-zero residual.

In the following, simulation results for some embodiments of in-loop filters are presented, which are based on various models with different complexities and provide performance-complexity analysis for them. For this, two models were selected among the models mentioned above and trained based on the BVI-DVC data set [19] where only the luma-components of the signals were used for training. The training data was generated by compressing the raw video data by the VVC test model version VTM-13.0 [20] under the RA configuration with QPs from the set {22, 27, 32, 37, 42} and extracting the reconstructed frames before ALF as well as the reconstructed frames before any in-loop filter and the prediction signal. The first model was trained on I-frames while the 2nd model was trained on B-frames.

In technical terms, the training made use of the Adam optimization [21] with the mean squared error (MSE) loss function

$${LOSS}_{MSE} = {‖ x - y - {\sum }_{k = 1}^{L} ( {ϕ}_{k} ( y \vert Θ ) \cdot ( y * {f}_{k} ) ) ‖}_{2}^{2}$$

for the input and target frames y and x. For the 9-layer models, this loss function was modified to

$${LOSS}_{9 - layer} = \frac{{LOSS}_{MSE} + {LOSS}_{scaled}}{2} , \\ where \\ {LOSS}_{scaled} = {min}_{( {c}_{1} , … , {c}_{L} )} {‖ x - y - {\sum }_{k = 1}^{L} {c}_{k} ( {ϕ}_{k} ( y \vert Θ ) \cdot ( y * {f}_{k} ) ) ‖}_{2}^{2}$$

adds scaling coefficients cₖ for the individual classes which are derived by a Gram-Schmidt process [22]. The main purpose of this loss function is to simulate the 2nd filtering process (4) during the training of the CNN in-loop filter so that it is better adapted to that process. The training data batches were formed from randomly selected square blocks from the original sequences and the corresponding blocks in the reconstructed frames before ALF, the reconstructed frames before any in-loop filter and the prediction signal. In order to mitigate boundary effects, the blocks were extended by 8 samples on either side. The resulting extended blocks size was 166 for the 9-layer model and 80 for all other models.

After the training, the CNN-based in-loop filter was integrated into VTM-13.0 so that the first model is applied to frames of the lowest temporal level, which consists of I-frames and B-frames referencing only other frames of the lowest temporal level, while the second model is applied for all other frames. Whether the CNN-model corresponding to a frame's temporal level or the original ALF is to be applied is signalled on frame level and decided by an RD-decision at the encoder. If a CNN-model is applied, it can be switched on and off on CTU level where the switch is signalled. Moreover, it is also signalled on CTU level whether additionally the 2nd filtering from (4) is to be applied or not. For the 2nd filtering, the filters \tilde{f}ₖ are determined at the encoder by conducting an RD-search that is similar to the determination of the filter coefficients in the ALF-encoder of VTM. The filter coefficients are then signalled per frame. The CNN-based in-loop filter proposed in this paper is applied to the luma component only. For the chroma components, chroma-ALF and Cross-Component ALF (CCALF) [13] of VVC are still applied.

All experiments were conducted using the AI and RA configurations of the JVET common test conditions [23] with two sets of QP values, {22, 27, 32, 37} (low QP) and {27, 32, 37, 42} (high QP).

From the models described in Section 3, the following combinations of first and second models were chosen for evaluation:
7/7: 7-layer models are used for both the first and the second model. The results are the same as presented in [11].
7/7-(A, B, C): A 7-layer model is used for the first model while 7-layer-(A, B, C) models are used for the second model respectively.
11/11: 11-layer models are used for both the first and second model.
11/7-(A, B, C): An 11-layer model is used for the first model while 7-layer-(A, B, C) models are used for the second model respectively.
7/7 (resi): 7-layer models are used for both the first and the second models. On CTU level, the residual-based criterion described in Section 4 is applied determining whether to apply the CNN-based in-loop filter or not.
9/9 (ρ): A 9-layer model is used for both the first and second models.

During the RD-search, when deciding whether to enable the CNN-based in-loop filter on CTU level, we replace the original RD-cost CTU_CNN_inloop_filter_cost for applying the CNN-based in-loop filter on the given CTU by ρ·CTU_CNN_inloop_filter_cost where ρ>1 is a positive constant. Note that one can reduce the overall effective complexity of the CNN-based in-loop filter by choosing a larger value for ρ so that it is applied less frequently based on RD-search. In particular, we have three test settings where we choose ρ₁=1.005, ρ₂=1.007 and ρ₃=1.010 respectively.

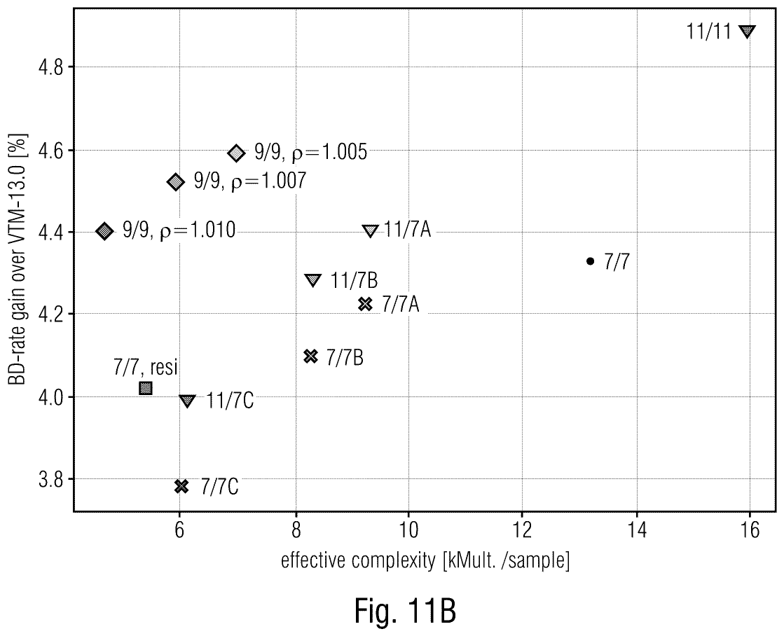

FIG. 11, including FIG. 11A and FIG. 11B, illustrates the performance-complexity trade-off for all the tests we described above, where the horizontal and vertical axes stand for the average effective complexity of the CNN-based in-loop filter and the average BD-rate saving over all VVC test sequences and all QP values considered (low/high-QP) respectively. The graphs of FIG. 11A and FIG. 11B show average effective complexity vs. BD-rate gain for CNN-based in-loop filters with various settings for RA, low QP in FIG. 11A and high QP in FIG. 11B. Here, for a given input frame, the effective number of multiplications per luma-pixel for CNN based in-loop filter is given by

$$= \frac{{128}^{2} \cdot ( {n}_{CNN} \cdot {CNN}_{} + {n}_{2 nd} \cdot {2 nd}_{} )}{{N}_{input - frame}} .$$

Here, n_{CNN} and n_{2nd} are the numbers of 128×128-CTU blocks where the CNN-based in-loop filters (2) and (4) are applied respectively. [symbol] _{CNN} is the total worst-case number of multiplications per luma-pixel for the CNN-based in-loop filter (2) associated with the model applied for the input frame—see Table 3. Similar, [symbol] _{2nd} is the total worst-case number of multiplications per luma-pixel for the CNN-based in-loop filter (4) given by the sum of [symbol] _{CNN} and the number of multiplications per luma-pixel for the 2nd filtering with the adaptive filters \tilde{f}ₖ—we refer to [11] for the complexity of the 2nd filtering. Finally N_{input-frame} is the total number of samples in the input frame. The average effective complexity of the CNN-based in-loop filter is then given by taking the average of the effective complexities [symbol] over all frames of all the input video sequences and over all QPs in the respective QP range (low/high-QP).

Note that the highest BD-rate saving is obtained by the 11/11 setting at the cost of the highest average effective complexity as illustrated in FIG. 11. On the other hand, under the RA configuration, the average effective complexity is reduced by about 50% or more for the 7/7C, 11/7C, 7/7 (resi) and 9/9 (ρ) settings compared to the 7/7 setting. In particular, the 9/9 (ρ₁) setting provides similar BD-rate savings over VVC with an average effective complexity reduced by about 50% compared to the 7/7 setting. However, note that these considerations apply to the effective complexity only. From Table 3, it can easily be derived that a reduction of the worst-case complexity is in particular achieved by the 7/7A, 7/7B and 7/7C settings as well as the 11/7A, 11/7B and 11/7C settings under the condition of a fixed maximum part of frames using the second model. Tables 4-5 show the results for the 9/9 (ρ₁) setting under the AI/RA configurations respectively.

TABLE 4
Rate-Distortion performance comparison for
9/9 (ρ₁ = 1.005) over VTM-13.0 in Al

| | Low QP | | | High QP | | |
|---|---|---|---|---|---|---|
| Class | Y | U | V | Y | U | V |
| A1 | −3.43% | 0.01% | 0.00% | −4.06% | −0.01% | −0.01% |
| A2 | −3.84% | −0.04% | −0.04% | −5.56% | −0.06% | −0.06% |
| B | −3.73% | −0.05% | −0.05% | −4.95% | −0.09% | −0.09% |
| C | −3.86% | −0.17% | −0.18% | −4.75% | −0.28% | −0.28% |
| E | −5.22% | −0.23% | −0.22% | −6.06% | −0.30% | −0.29% |
| Overall | −3.97% | −0.10% | −0.10% | −5.04% | −0.15% | −0.15% |
| D | −3.89% | −0.08% | −0.08% | −4.92% | −0.13% | −0.13% |

| | | |
|---|---|---|
| Enc time | 2.54× | 3.52× |
| Dec time | 52.05× | 68.40× |

TABLE 5
Rate-Distortion performance comparison for 9/9
(ρ₁ = 1.005) over VTM-13.0 in RA

| | Low QP | | | High QP | | |
|---|---|---|---|---|---|---|
| Class | Y | U | V | Y | U | V |
| A1 | −3.62% | −0.07% | 0.05% | −4.28% | 0.04% | 0.20% |
| A2 | −4.95% | 0.04% | −0.11% | −4.91% | 0.14% | 0.06% |
| B | −4.73% | −0.16% | −0.11% | −4.86% | 0.02% | 0.06% |
| C | −4.18% | 0.09% | −0.10% | −4.22% | 0.14% | 0.02% |
| Overall | −4.41% | −0.04% | −0.07% | −4.59% | 0.08% | 0.08% |
| D | −5.29% | 0.41% | 0.45% | −5.37% | 0.29% | 0.38% |

| | | |
|---|---|---|
| Enc time | 2.51× | 3.41× |
| Dec time | 44.91× | 51.38× |

To summarize, the experimental results for the above described analysis show that one can still achieve notable BD-rate savings over VVC with significantly reduced complexity compared to our previous work. In particular, using the above-described 9/9 (ρ₁) setup, may provide a similar BD-rate reduction of 4.41%/4.59% (for luma, low/high-QP) under the RA configuration with a reduced average effective complexity of only 6.79/7.00 kmul/sample compared to 4.39%/4.33% at 13.95/13.17 kmul/sample for the 7/7 setting [11]. Thus, the effective complexity was reduced from about 14 kmul/sample to about 7 kmul/sample while the overall coding gain essentially remained the same.

In the following, further implementation alternatives are described, referring to all of the embodiments described above.

Although some aspects have been described as features in the context of an apparatus it is clear that such a description may also be regarded as a description of corresponding features of a method. Although some aspects have been described as features in the context of a method, it is clear that such a description may also be regarded as a description of corresponding features concerning the functionality of an apparatus.

In particular, it is noted that FIG. 4 may also be regarded as illustration of a method for decoding a video and FIG. 5 may be regarded as illustration of a method for encoding a video, where the blocks, modules and stages may be regarded as steps of methods.

Some or all of the method steps may be executed by (or using) a hardware apparatus, like for example, a microprocessor, a programmable computer or an electronic circuit. In some embodiments, one or more of the most important method steps may be executed by such an apparatus.

The inventive encoded image signal can be stored on a digital storage medium or can be transmitted on a transmission medium such as a wireless transmission medium or a wired transmission medium such as the Internet. In other words, further embodiments provide a video bitstream product including the video bitstream according to any of the herein described embodiments, e.g. a digital storage medium having stored thereon the video bitstream.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

In the foregoing Detailed Description, it can be seen that various features are grouped together in examples for the purpose of streamlining the disclosure. This method of disclosure is not to be interpreted as reflecting an intention that the claimed examples require more features than are expressly recited in each claim. Rather, as the following claims reflect, subject matter may lie in less than all features of a single disclosed example. Thus the following claims are hereby incorporated into the Detailed Description, where each claim may stand on its own as a separate example. While each claim may stand on its own as a separate example, it is to be noted that, although a dependent claim may refer in the claims to a specific combination with one or more other claims, other examples may also include a combination of the dependent claim with the subject matter of each other dependent claim or a combination of each feature with other dependent or independent claims. Such combinations are proposed herein unless it is stated that a specific combination is not intended. Furthermore, it is intended to include also features of a claim to any other independent claim even if this claim is not directly made dependent to the independent claim.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] ITU-T and ISO/IEC “Advanced Video Coding for Generic Audiovisual Services” H.264 and ISO/IEC 14496-10, vers. 1, 2003.
[2] T. Wiegand, G. J. Sullivan, G. BjÃ,ntegaard and A. Luthra, “Overview of the H.264/AVC video coding standard,” IEEE Trans. Circuits Syst. Video Technol., vol. 13, pp. 560-576, 2003.
[3] ITU-T and ISO/IEC “High Efficiency Video Coding” H.265 and ISO/IEC 23008-2, vers. 1, 2013.
[4] G. J. Sullivan, J.-R. Ohm, W.-J. Han and T. Wiegand, “Overview of the high efficiency video coding (HEVC) standard,” IEEE Trans. Circuits Syst. Video Technol., vol. 22, pp. 1649-1668, 2012.
[5] ITU-T and ISO/IEC “Versatile Video Coding” H.266 and ISO/IEC 23090-3, 2020.
[6] B. Bross et al. “Overview of the Versatile Video Coding (VVC) Standard and its Applications,” IEEE Trans. Circuits Syst. Video Technol., vol. 31, pp. 3736-3764, 2021.
[7] P. List, A. Joch, J. Lainema, G. BjÃ,ntegaard and M. Karczewicz, “Adaptive deblocking filter,” IEEE Trans. Circuits Syst. Video Technol., vol. 13, pp. 614-619, 2003.
[8] W. Jia, L. Li, Z. Li, X. Zhang and S. Liu, “Residual Guided Deblocking With Deep Learning,” in 2020 IEEE International Conference on Image Processing (ICIP), IEEE, 2020, pp. 3109-3113.
[9] C. Jia et al., “Content-Aware Convolutional Neural Network for In-Loop Filtering in High Efficiency Video Coding,” IEEE Transactions on Image Processing, vol. 28, pp. 3343-3356 July 2019.
[10] D. Ma, F. Zhang and D. R. Bull, “MFRNet: A New CNN Architecture for Post-Processing and In-loop Filtering,” IEEE Journal of Selected Topics in Signal Processing, vol. 15, pp. 378-387, 2021.
[11] W. Lim, P. Jonathan, B. Stallenberger, E. Johannes, H. Schwarz, D. Marpe and T. Wiegand, “Adaptive Loop Filter with a CNN-based classification” 2022 IEEE International Conference on Image Processing (ICIP), to be published.
[12] M. Karczewicz, L. Zhang, W. Chien and X. Li, “Geometry transformation-based adaptive in-loop filter,” in Proc. Picture Coding Symposium (PCS), 2016, pp. 1-5.
[13] M. Karczewicz et al., “VVC In-Loop Filters,” IEEE Trans. Circuits Syst. Video Technol., vol. 31, pp. 3907-3925, 2021.
[14] S. Ioffe and C. Szegedy, “Batch normalization: Accelerating deep network training by reducing internal covariate shift,” in International Conference on Machine Learning (ICML), 2015, pp. 448-456.
[15] V. Nair and G. E. Hinton, “Rectified linear units improve restricted Boltzmann machines,” in Proc. 27th Int. Conf. Mach. Learn. (ICML), 2010, pp. 807-814.
[16] I. Goodfellow, Y. Bengio and A. Courville, “Softmax Units for Multinoulli Output Distributions,” in Deep Learning, MIT Press., 2016, pp. 180-184.
[17] A. Howard et. al., “Mobilenets: Efficient convolutional neural networks for mobile vision applications,” in arXiv:1704.04861, 2017.
[18] K. He, X. Zhang, S. Ren and J. Sun, “Deep Residual Learning for Image Recognition,” in IEEE Conference on Computer Vision and Pattern Recognition (CVPR), 2016, pp. 770-778
[19] D. Ma, F. Zhang and D. R. Bull, “BVI-DVC: a training database for deep video compression,” in arXiv:2003.13552, 2020.
[20] “VVC Reference Software Version 13.0” https://vcgit.hhi.fraunhofer.de/jvet/VVCSoftware_VTM.
[21] D. P. Kingma and J. Ba., “Adam: A method for stochastic optimization,” in Int. Conf. Learn. Represent. (ICLR), 2015, pp. 1-15.
[22] G. H. Golub and C. Van Loan, “Matrix Computations,” Johns Hopkins, 3rd ed., 1996
[23] F. Bossen, J. Boyce, X. Li, V. Seregin, K. Sühring, “JVET common test conditions and software reference configurations for SDR video,” in 14th JVET meeting, no. JVET-N1010, March 2019.

1. An apparatus for decoding a video from a bitstream, wherein the apparatus is configured to:
reconstruct, based on the bitstream, the video using block-based predictive decoding, transform-based residual decoding and a prediction loop into which an in-loop filter tool is serially connected, the in-loop filter tool comprising a serial connection of a first in-loop filter and a second in-loop filter,
wherein the second in-loop filter is configured to subject pre-reconstructed samples of a current picture to an adaptive in-loop filtering, ALF,
wherein the second in-loop filter is configured to perform, based on the bitstream, a mode switching
between (alternative 1)
one or more first modes of performing the adaptive in-loop filtering, and
one or more second modes of performing the adaptive in-loop filtering, wherein the one or more first modes are computationally more complex than the one or more second modes, or
between (alternative 2)
one or more first modes of performing the adaptive in-loop filtering, and
one or more second modes of performing the adaptive in-loop filtering, wherein the one or more first modes are computationally more complex than the one or more second modes, and
a third mode of bypassing the second in-loop filter, or
between (alternative 3)
one or more first modes of performing the adaptive in-loop filtering, with each of the first modes using a CNN, and
optionally, a second mode of bypassing the second in-loop filter.

2. The apparatus of claim 1, wherein
the one or more first modes involve the second in-loop filter assigning a classification to pre-reconstructed samples of the current picture and filtering the pre-reconstructed samples with a filter transfer function which is adapted to the classification.

3. The apparatus of claim 1, wherein
the one or more second modes involve the second in-loop filter assigning a further classification to pre-reconstructed samples of the current picture and filtering the pre-reconstructed samples with a filter transfer function which is adapted to the further classification.

4. The apparatus of claim 2, wherein
the classification of the one or more first modes is a soft-classification.

5. The apparatus of claim 2, wherein
the classification of the one or more second modes is a hard-classification.

6. The apparatus of claim 2, wherein
the classification of the one or more first modes is CNN based.

7. The apparatus of claim 2, wherein
the further classification of the one or more second modes is based on an analysis of local activity and directionality.

8. The apparatus of claim 1, wherein the second in-loop filter is configured to perform the adaptive in-loop filtering by use of FIR filters adapted in a sample-wise manner.

9. The apparatus of claim 1, wherein the one or more first modes are CNN based and/or the second one or more second modes non-CNN based.

10. The apparatus of claim 1, wherein the one or more first modes involve the second in-loop filter assigning a classification to pre-reconstructed samples of the current picture and filtering the pre-reconstructed samples with a filter transfer function which is adapted to the classification, the classification of the one or more first modes is a soft-classification, wherein the second in-loop filter is configured to
perform the soft classification for first pre-reconstructed samples by
assigning, for each first pre-reconstructed sample, a classification value to each of a first set of classes, with each of which an associated FIR filter is associated, and
performing the adaptive in-loop filtering, in case of using the soft classification for the assigning the classification, by, at each first pre-reconstructed sample,
applying, for each class of the first set of classes, the associated FIR filter associated with the respective class to the pre-reconstructed samples to obtain a filter result, and
forming a weighted sum of the filter results of the first set of classes according to the classification values.

11. The apparatus of claim 1, wherein the one or more first modes involve the second in-loop filter assigning a classification to pre-reconstructed samples of the current picture and filtering the pre-reconstructed samples with a filter transfer function which is adapted to the classification, the one or more second modes involve the second in-loop filter assigning a further classification to pre-reconstructed samples of the current picture and filtering the pre-reconstructed samples with a filter transfer function which is adapted to the further classification, the classification of the one or more first modes is a soft-classification, and the classification of the one or more second modes is a hard-classification.

12. The apparatus of claim 11, wherein the second in-loop filter is configured to
perform the soft classification for first pre-reconstructed samples by
assigning, for each first pre-reconstructed sample, a classification value to each of a first set of classes, with each of which an associated FIR filter is associated, and
performing the adaptive in-loop filtering, in case of using the soft classification for the assigning the classification, by, at each first pre-reconstructed sample,
applying, for each class of the first set of classes, the associated FIR filter associated with the respective class to the pre-reconstructed samples to obtain a filter result, and
forming a weighted sum of the filter results of the first set of classes according to the classification values; and
perform the hard classification for second pre-reconstructed samples by
assigning a local activity and directionality information to each second pre-reconstructed sample and
assigning to each second pre-reconstructed sample a classification index into a second set of classes, with each of which an associated FIR filter is associated, based on the local activity and directionality information assigned to the respective second pre-reconstructed sample, and
performing the adaptive in-loop filtering, in case of using the hard classification for the assigning the classification, by
applying to the pre-reconstructed samples, at each second pre-reconstructed sample, the associated FIR filter associated with a class of the second set of classes, onto which the classification index points which is assigned to the respective second pre-reconstructed sample.

13. The apparatus of claim 12, wherein the adaptive in-loop filtering, in case of using the soft classification for the assigning the classification, is according to:
$$\hat{y} = y + {\sum }_{k = 1}^{L} {ϕ}_{k} ( y \vert Θ ) \cdot ( y * {f}_{k} )$$
wherein ŷ are the samples resulting from the adaptive in-loop filtering; y are pre-reconstructed samples, L is the number of classes in the first set; Φₖ is the classification value for class k and fₖ is the FIR filter associated with class k of the first set.

14. The apparatus of claim 12, wherein the adaptive in-loop filtering, in case of using the hard classification for the assigning the classification, is according to:
$$\hat{y} = y + {\sum }_{k = 1}^{L} {χ}_{{C}_{k}} \cdot ( y * {f}_{k} ) .$$
wherein ŷ are the samples resulting from the adaptive in-loop filtering; y are pre-reconstructed samples, L is the number of classes in the first set; χ_{C}_{ₖ} is a function assigning 1 to each pre-reconstructed sample to which classification index k is assigned, and zero otherwise, and fₖ is the FIR filter associated with class k of the second set.

15. The apparatus of claim 11, wherein the soft classification is implemented at least in parts by a CNN that comprises a convolution layer and a number of basic layer groups.

16. The apparatus of claim 15, wherein the CNN comprises exactly one convolution layer and exactly 7, 9 or 11 basic layer groups.

17. The apparatus of claim 16, wherein a structure of the CNN is based on any of the following variants in column “7 layer”, “9 layer” or “11 layer”:

| layer/model | 7 layer | 9 layer | 11 layer | Type |
|---|---|---|---|---|
| clipping | (7, 1, 4) | (3, 1, 4) | (7, 1, 4) | NS |
| 1st BLG | (3, 8, 32) | (3, 8, 32) | (3, 8, 32) | NS |
| 2nd BLG | (3, 32, 64) | (3, 32, 32) | (3, 32, 32) | DS |
| 3rd BLG | (3, 64, 64) | (3, 32, 64) | (3, 32, 64) | DS |
| 4th BLG | (3, 64, 64) | (3, 64, 64) | (3, 64, 64) | DS |
| 5th BLG | (3, 64, 128) | (3, 64, 64) | (3, 64, 64) | DS |
| 6th BLG | (3, 128, 25) | (3, 64, 64) | (3, 64, 64) | DS |
| 7th BLG | (3, 25, 25) | (3, 64, 40) | (3, 64, 64) | DS |
| 8th BLG | | (3, 40, 25) | (3, 64, 64) | DS |
| 9th BLG | | (3, 25, 25) | (3, 64, 64) | DS |
| 10th BLG | | | (3, 64, 25) | DS |
| 11th BLG | | | (3, 25, 25) | DS |

wherein (K, Nᵢₙ, Nₒᵤₜ) refers to kernel size K, a number of input channels Nᵢₙ and a number of output channels Nₒᵤₜ; wherein a type of the layer indicates a type of convolution as non-separable, NS; or depth-wise separable, DS.

18. The apparatus of claim 17, wherein Θ defines the weights of at least one, of some or all layers of a CNN used for the assigning of the classification value to each class of the first set or the second set.

19. The apparatus of claim 11, wherein the apparatus is configured to implement the soft classification by convoluting, batch-normalizing implementing a rectified linear (ReLU) activation function.

20. The apparatus of claim 11, wherein the apparatus is configured to implement the soft classification by use of a CNN that is adapted to use at least one of:
a quantization parameter, QP, information, e.g., a QP parameter, assigned to the current picture;
a reconstructed version of the current picture inbound to the first in-loop filter (e.g. which comprises a deblocking filter, DBF, or a DBF followed by SAO filter); and
a prediction signal of the current frame (e.g. predicted samples without prediction residual applied thereonto).

21. The apparatus of claim 11, wherein a 1^{st} basic layer group of a CNN of the soft classification is adapted to receive 8 input channels, advantageously exactly 8 input channels.

22. The apparatus of claim 21, wherein the 8 input channels comprise:
a quantization parameter, QP, information, e.g., a QP parameter, assigned to the current picture;
a reconstructed version of the current picture inbound to the first in-loop filter (e.g. which comprises a deblocking filter, DBF, or a DBF followed by SAO filter); and
a prediction signal of the current frame (e.g. predicted samples without prediction residual applied thereonto).
four output channels of a convolutional layer preceding and connected to the 1^{st} basic layer group; and
the pre-reconstructed samples.

23. The apparatus of claim 11, wherein the soft classification is to identify dominant features around a sample location.

24. The apparatus of claim 11, wherein the soft classification comprises a subsampler for providing a subsampling operator.

25. The apparatus of claim 24, wherein, for implementing the subsampling operator, the soft classification comprises a CNN that comprises a max pooling operator with 3×3 window followed by a 2DN downsampling with factor 2 that is applied to output channels of a second basic layer group of the CNN; wherein in a last layer of the CNN, the downsampling step is reverted by an upsampling with trained upsampling filters.

26. The apparatus of claim 11, wherein the soft classification is configured for a depth-wise separable convolution.

27. The apparatus of claim 26, wherein the depth-wise separable convolution comprises a filtering process in two parts; wherein a first part comprises a 2D convolution with a k₁×k₂ kernel that is performed independently over each input channel of the soft classification; wherein a second part comprises a full convolution but with 1×1 kernels that is applied across all channels.

28. The apparatus of claim 11, wherein the soft classification is adapted for applying a softmax function to a output channels of a last, e.g. seventh, basic layer group of the soft classification.

29. The apparatus of claim 11, wherein the softmax function comprises a structure based on
$${ϕ}_{k} ( i ) = \frac{exp ( {ψ}_{k} ( i ) )}{{\sum }_{ℓ = 1}^{L} exp ( {ψ}_{ℓ} ( i ) )} for i ∈ I .$$
wherein Φₖ(i) is interpretable as an estimated probability that the corresponding sample location i∈I is associated with a class of index k; Φₖ is a classification output; and ψₗ are the output channels of the last basic layer group.

30. The apparatus of claim 11, wherein the ALF is adapted for applying multiple 2D filters (fₖ) for different classes k to the classified samples.

31. The apparatus of claim 11, wherein the ALF is adapted for filtering the classified samples with a clipping function to reduce the impact of neighbour sample values when they are too different with the current sample value being filtered.

32. The apparatus of claim 11, wherein clipping function is based on the determination rule
$${\sum }_{i \neq ( 0 , 0 )} f ( i ) Clip ( y ( x + i ) - y ( x ) , ρ ( i ) )$$
to modify the filtering of the input signal y with a 2D-filter f at sample local x wherein ‘Clip’ is the clipping function defined by Clip(d; b)=min(b; max(−b; d)) and ρ(i) are trained clipping parameters used for the filtering process y*fₖ and for a first convolutional layer of a CNN of the soft classification.

33. The apparatus of claim 11, wherein coefficients of the FIR filters associated with the classes of first set of classes are received as part of the bitstream.

34. The apparatus of claim 11, wherein the FIR filters associated with the classes of first and second sets of classes comprise a diamond shape.

35. The apparatus of claim 1, configured to perform the mode switching in units of one or more of
coding treeroot blocks into which the current picture is pre-subdivided in rows and columns of coding treeroot blocks, and from which onwards the picture is subdivided into coding blocks by recursive multi-tree partitioning of the coding treeroot blocks,
coding blocks into which the current picture is subdivided by pre-subdividing the current picture into coding treeroot blocks in rows and columns of coding treeroot blocks, and subdividing the picture further from the coding treeroot blocks onwards by recursive multi-tree partitioning g of the coding treeroot blocks, and
slices of the current picture.

36. The apparatus of claim 1, configured to perform the mode switching by use of a syntax element in the bitstream.

37. The apparatus of claim 36, wherein the syntax element is signalled in the bitstream individually for
coding treeroot blocks into which the current picture is pre-subdivided in rows and columns of coding treeroot blocks, and from which onwards the picture is subdivided into coding blocks by recursive multi-tree partitioning of the coding treeroot blocks,
coding blocks into which the current picture is subdivided by pre-subdividing the current picture into coding treeroot blocks in rows and columns of coding treeroot blocks, and subdividing the picture further from the coding treeroot blocks onwards by recursive multi-tree partitioning g of the coding treeroot blocks, and
slices of the current picture.

38. The apparatus of claim 36, configured to perform the mode switching by
estimating a measure of complexity incurred by the second in-loop filter or the one or more first modes of the second in-loop filter within a predetermined video or picture section so far, and
checking whether the estimation fulfills a predetermined criterion (e.g. exceeds a threshold), and if so, inferring that the syntax element, if same relates to the predetermined video or picture section,
assumes a predetermined value not corresponding to any first mode, or any first mode exceeding a predetermined complexity, or
has a decreased value domain which excludes the one or more first modes, or any first mode exceeding the predetermined complexity, and is decreased relative to a complete value domain the syntax element has outside the predetermined video or picture section, so that a bit rate for signaling at least one value in the decreased value domain, which does not correspond to any first mode, or any first mode exceeding the predetermined complexity, has a smaller bitrate consumption than compared to a corresponding value in the complete value domain.

39. The apparatus of claim 1, configured to perform the mode switching based on an estimation of a measure of complexity incurred by the second in-loop filter or the one or more first modes of the second in-loop filter within a predetermined video or picture section so far by disabling the one or more first modes, or any first mode exceeding a predetermined complexity for the predetermined video or picture section if the estimation fulfills a predetermined criterion (e.g. exceeds a threshold).

40. The apparatus of claim 36, configured to perform the mode switching by
determining, within a predetermined picture area, a measure for prediction quality or prediction imperfection within the predetermined picture area, and
checking whether the measure for prediction or prediction imperfection fulfills a further predetermined criterion, and if so, inferring that the syntax element, if same relates to the predetermined picture area,
assumes a predetermined value not corresponding to any first mode, or any first mode exceeding a predetermined complexity, or
has a decreased value domain which excludes the one or more first modes, or any first mode exceeding the predetermined complexity, and is decreased relative to a complete value domain the syntax element has outside the predetermined picture area, so that a bit rate for signaling at least one value in the decreased value domain, which does not correspond to any first mode, or any first mode exceeding the predetermined complexity, has a smaller bitrate consumption than compared to a corresponding value in the complete value domain.

41. The apparatus of claim 1, configured to perform the mode switching based on measure for prediction quality or prediction imperfection within a predetermined picture area by disabling the one or more first modes, or any first mode exceeding the predetermined complexity, for the predetermined picture area if the measure for prediction quality or prediction imperfection fulfills a further predetermined criterion.

42. The apparatus of claim 40, wherein the measure for prediction quality or prediction imperfection includes one or more of
the prediction residual being zero within the predetermined picture area,
the areal fraction in which the prediction residual is zero,
a number of coded non-zero transform coefficients,
an energy of coded transform coefficients.

43. The apparatus of claim 40, wherein the predetermined picture area is a coding treeroot block, coding block, or slice.

44. The apparatus of claim 36, configured to perform the mode switching by
determining a prediction type or inter-prediction hierarchy level of a picture, and
checking whether the prediction type or inter-prediction hierarchy level fulfils an even further predetermined criterion, and if so, inferring that the syntax element, if same relates to the picture,
assumes a predetermined value not corresponding to any first mode, or any first mode exceeding a predetermined complexity, or
has a decreased value domain which excludes the one or more first modes, or any first mode exceeding a predetermined complexity, and is decreased relative to a complete value domain the syntax element has outside the picture, so that a bit rate for signaling at least one value in the decreased value domain, which does not correspond to any first mode, or any first mode exceeding the predetermined complexity, has a smaller bitrate consumption than compared to a corresponding value in the complete value domain.

45. The apparatus of claim 1, configured to perform the mode switching based on prediction type or inter-prediction hierarchy level of a picture by disabling the one or more first modes, or any first mode exceeding a predetermined complexity for the picture if the measure for prediction quality or prediction imperfection fulfills a even further predetermined criterion.

46. The apparatus of claim 44, wherein the prediction type indicates whether the picture is inter-predicted based on reference pictures preceding and succeeding the picture in presentation time order, with the even further predetermined criterion being fulfilled if this is the case, and/or the inter-prediction hierarchy level of a picture indicates a temporal hierarchy level of the picture in a GOP, with the even further predetermined criterion being fulfilled if the hierarchy level exceeds same threshold.

47. The apparatus of claim 36, configured to perform the mode switching by
checking whether a predetermined picture portion has at least one reference picture which succeeds a picture of the predetermined picture portion in presentation time order, and
if so, inferring that the syntax element, if same relates to the predetermined picture portion,
assumes a predetermined value not corresponding to any first mode, or any first mode exceeding a predetermined complexity, or
has a decreased value domain which excludes the one or more first modes, or any first mode exceeding a predetermined complexity, and is decreased relative to a complete value domain the syntax element has outside the predetermined picture portion, so that a bit rate for signaling at least one value in the decreased value domain, which does not correspond to any first mode, or any first mode exceeding the predetermined complexity, has a smaller bitrate consumption than compared to a corresponding value in the complete value domain.

48. The apparatus of claim 1, configured to perform the mode switching in dependence on whether for a predetermined picture portion at least one reference picture succeeds a picture of the predetermined picture portion in presentation time order by disabling the one or more first modes, or any first mode exceeding the predetermined complexity for the predetermined picture portion if this is the case.

49. The apparatus of claim 47, wherein the predetermined picture portion is a slice or a whole picture.

50. The apparatus of claim 36, configured to perform the mode switching by
checking whether a further predetermined picture portion is, within at least one block, or completely intra coded, and
if so, inferring that the syntax element, if same relates to the further predetermined picture portion,
assumes a predetermined value not corresponding to any first mode, or any first mode exceeding a predetermined complexity, or
has a decreased value domain which excludes each first mode, or any first mode exceeding a predetermined complexity, and is decreased relative to a complete value domain the syntax element has outside the further predetermined picture portion, so that a bit rate for signaling at least one value in the decreased value domain, which does not correspond to any first mode, or any first mode exceeding the predetermined complexity, has a smaller bitrate consumption than compared to a corresponding value in the complete value domain.

51. The apparatus of claim 1, configured to perform the mode switching in dependence on whether a further predetermined picture portion is, within at least one block, or completely intra coded by disabling the one or more first modes, or any first mode exceeding a predetermined complexity for the further predetermined picture portion if this is the case.

52. The apparatus of claim 47, wherein the predetermined picture portion is a slice, a whole picture or a CTU or a CU.

53. The apparatus of claim 1, wherein the soft classification is adapted to provide for a number of at most 35000, e.g., 29873, trained parameters.

54. The apparatus of claim 1, wherein the second in-loop filter is configured to
perform the soft classification for first pre-reconstructed samples by assigning, for each first pre-reconstructed sample, a classification value to each of a first set of classes, with each of which an associated first FIR filter and a second filter is associated, and performing the adaptive in-loop filtering, in case of using the soft classification for the assigning the classification, by
applying, for each class of the first set of classes, the associated first FIR filter associated with the respective class onto the pre-reconstructed samples to obtain a first filtered version,
weighting, for each class of the first set of classes, the first filtered version at each sample position with the classification value assigned to the respective class for the first pre-reconstructed sample at the respective sample position to obtain an second filtered version,
applying, for each class of the first set of classes, the associated second FIR filter associated with the respective class onto the second filtered version to obtain a third filtered version,
subjecting, for each second pre-filtered version, the third filtered version obtained for the classes of the first set, to a summation,
wherein for each class of the first set of classes coefficients, and/or a size and/or shape of a kernel of the second FIR filter are conveyed in the bitstream.

55. The apparatus of claim 1, wherein the second in-loop filter is configured to switch, based on the bitstream, between
performing the soft classification for first pre-reconstructed samples in a first manner by assigning, for each first pre-reconstructed sample, a classification value to each of a first set of classes, with each of which an associated FIR filter is associated, and performing the adaptive in-loop filtering, in case of using the soft classification for the assigning the classification, by applying, at each first pre-reconstructed sample, for each class of the first set of classes, the associated FIR filter associated with the respective class to the pre-reconstructed samples to obtain a filter result, and forming a weighted sum of the filter results of the first set of classes according to the classification values; and
performing the soft classification for first pre-reconstructed samples in a second manner by assigning, for each first pre-reconstructed sample, a classification value to each of a first set of classes, with each of which an associated first FIR filter and a second filter is associated, and performing the adaptive in-loop filtering, in case of using the soft classification for the assigning the classification, by
applying, for each class of the first set of classes, the associated first FIR filter associated with the respective class onto the pre-reconstructed samples to obtain a first filtered version,
weighting, for each class of the first set of classes, the first filtered version at each sample position with the classification value assigned to the respective class for the first pre-reconstructed sample at the respective sample position to obtain an second filtered version,
applying, for each class of the first set of classes, the associated second FIR filter associated with the respective class onto the second filter version to obtain a third filtered version,
subjecting, for each second pre-filtered version, the third filtered version obtained for the classes of the first set, to a summation,
wherein for each class of the first set of classes coefficients, and/or a size and/or shape of a kernel of the second FIR filter are conveyed in the bitstream.

56. The apparatus of claim 55, configured to perform the switching between performing the performing the soft classification for first pre-reconstructed samples in the first or second manner in units of one or more of
coding treeroot blocks into which the current picture is pre-subdivided in rows and columns of coding treeroot blocks, and from which onwards the picture is subdivided into coding blocks by recursive multi-tree partitioning of the coding treeroot blocks,
coding blocks into which the current picture is subdivided by pre-subdividing the current picture into coding treeroot blocks in rows and columns of coding treeroot blocks, and subdividing the picture further from the coding treeroot blocks onwards by recursive multi-tree partitioning of the coding treeroot blocks, and
slices of the current picture;
pictures of the video,
a sequence of Pictures of the video,
the video.

57. The apparatus of claim 1, configured to perform the switching between performing the soft classification for first pre-reconstructed samples in the first or second manner based on an estimation of a measure for multiplications per sample incurred by the second in-loop filter for the current picture so far by disabling the soft classification if the estimation fulfills a predetermined criterion (e.g. exceeds a threshold).

58. An apparatus for encoding a video into a bitstream, wherein the apparatus is configured to:
encode, into the bitstream, the video using block-based predictive encoding, transform-based residual encoding and a prediction loop into which an in-loop filter tool is serially connected, the in-loop filter tool comprising a serial connection of a first in-loop filter and a second in-loop filter,
wherein the second in-loop filter is configured to subject pre-reconstructed samples of a current picture to an adaptive in-loop filtering, ALF,
wherein the second in-loop filter is configured to perform, and signal in the bitstream, a mode switching
between (alternative 1)
one or more first modes of performing the adaptive in-loop filtering, and
one or more second modes of performing the adaptive in-loop filtering, wherein the one or more first modes are computationally more complex than the one or more second modes, or
between (alternative 2)
one or more first modes of performing the adaptive in-loop filtering, and
one or more second modes of performing the adaptive in-loop filtering, wherein the one or more first modes are computationally more complex than the one or more second modes, and
a third mode of bypassing the second in-loop filter, or
between (alternative 3)
one or more first modes of performing the adaptive in-loop filtering, with each of the first modes using a CNN, and
optionally, a second mode of bypassing the second in-loop filter.

59. The apparatus of claim 58, wherein
the one or more first modes involve the second in-loop filter assigning a classification to pre-reconstructed samples of the current picture and filtering the pre-reconstructed samples with a filter transfer function which is adapted to the classification.

60. The apparatus of claim 58, wherein
the one or more second modes involve the second in-loop filter assigning a further classification to pre-reconstructed samples of the current picture and filtering the pre-reconstructed samples with a filter transfer function which is adapted to the further classification.

61. The apparatus of claim 59, wherein
the classification of the one or more first modes is a soft-classification.

62. The apparatus of claim 59, wherein
the classification of the one or more second modes is a hard-classification.

63. The apparatus of claim 59, wherein
the classification of the one or more first modes is CNN based.

64. The apparatus of claim 59, wherein
the further classification of the one or more second modes is based on an analysis of local activity and directionality.

65. The apparatus of claim 58, wherein the second in-loop filter is configured to perform the adaptive in-loop filtering by use of FIR filters adapted in a sample-wise manner.

66. The apparatus of claim 58, wherein the one or more first modes are CNN based and/or the second one or more second modes non-CNN based.

67. The apparatus of claim 58, wherein the one or more first modes involve the second in-loop filter assigning a classification to pre-reconstructed samples of the current picture and filtering the pre-reconstructed samples with a filter transfer function which is adapted to the classification, the classification of the one or more first modes is a soft-classification, wherein the second in-loop filter is configured to
perform the soft classification for first pre-reconstructed samples by
assigning, for each first pre-reconstructed sample, a classification value to each of a first set of classes, with each of which an associated FIR filter is associated, and
performing the adaptive in-loop filtering, in case of using the soft classification for the assigning the classification, by, at each first pre-reconstructed sample,
applying, for each class of the first set of classes, the associated FIR filter associated with the respective class to the pre-reconstructed samples to obtain a filter result, and
forming a weighted sum of the filter results of the first set of classes according to the classification values.

68. The apparatus of claim 58, wherein the one or more first modes involve the second in-loop filter assigning a classification to pre-reconstructed samples of the current picture and filtering the pre-reconstructed samples with a filter transfer function which is adapted to the classification, the one or more second modes involve the second in-loop filter assigning a further classification to pre-reconstructed samples of the current picture and filtering the pre-reconstructed samples with a filter transfer function which is adapted to the further classification, the classification of the one or more first modes is a soft-classification, and the classification of the one or more second modes is a hard-classification.

69. The apparatus of claim 68, wherein the second in-loop filter is configured to
perform the soft classification for first pre-reconstructed samples by
assigning, for each first pre-reconstructed sample, a classification value to each of a first set of classes, with each of which an associated FIR filter is associated, and
performing the adaptive in-loop filtering, in case of using the soft classification for the assigning the classification, by, at each first pre-reconstructed sample,
applying, for each class of the first set of classes, the associated FIR filter associated with the respective class to the pre-reconstructed samples to obtain a filter result, and
forming a weighted sum of the filter results of the first set of classes according to the classification values; and
perform the hard classification for second pre-reconstructed samples by
assigning a local activity and directionality information to each second pre-reconstructed sample and
assigning to each second pre-reconstructed sample a classification index into a second set of classes, with each of which an associated FIR filter is associated, based on the local activity and directionality information assigned to the respective second pre-reconstructed sample, and
performing the adaptive in-loop filtering, in case of using the hard classification for the assigning the classification, by
applying to the pre-reconstructed samples, at each second pre-reconstructed sample, the associated FIR filter associated with a class of the second set of classes, onto which the classification index points which is assigned to the respective second pre-reconstructed sample.

70. The apparatus of claim 69, wherein the adaptive in-loop filtering, in case of using the soft classification for the assigning the classification, is according to:
$$\hat{y} = y + {\sum }_{k = 1}^{L} {ϕ}_{k} ( y \vert Θ ) \cdot ( y * {f}_{k} )$$
wherein ŷ are the samples resulting from the adaptive in-loop filtering; y are pre-reconstructed samples, L is the number of classes in the first set; Φₖ is the classification value for class k and fₖ is the FIR filter associated with class k of the first set.

71. The apparatus of claim 69, wherein the adaptive in-loop filtering, in case of using the hard classification for the assigning the classification, is according to:
$$\hat{y} = y + {\sum }_{k = 1}^{L} {χ}_{{C}_{k}} \cdot ( y * {f}_{k} ) .$$
wherein ŷ are the samples resulting from the adaptive in-loop filtering; y are pre-reconstructed samples, L is the number of classes in the first set; χ_{C}_{ₖ} is a function assigning 1 to each pre-reconstructed sample to which classification index k is assigned, and zero otherwise, and fₖ is the FIR filter associated with class k of the second set.

72. The apparatus of claim 68, wherein the soft classification is implemented at least in parts by a CNN that comprises a convolution layer and a number of basic layer groups.

73. The apparatus of claim 72, wherein the CNN comprises exactly one convolution layer and exactly 7, 9 or 11 basic layer groups.

74. The apparatus of claim 73, wherein a structure of the CNN is based on any of the following variants in column “7 layer”, “9 layer” or “11 layer”:

| layer/model | 7 layer | 9 layer | 11 layer | Type |
|---|---|---|---|---|
| clipping | (7, 1, 4) | (3, 1, 4) | (7, 1, 4) | NS |
| 1st BLG | (3, 8, 32) | (3, 8, 32) | (3, 8, 32) | NS |
| 2nd BLG | (3, 32, 64) | (3, 32, 32) | (3, 32, 32) | DS |
| 3rd BLG | (3, 64, 64) | (3, 32, 64) | (3, 32, 64) | DS |
| 4th BLG | (3, 64, 64) | (3, 64, 64) | (3, 64, 64) | DS |
| 5th BLG | (3, 64, 128) | (3, 64, 64) | (3, 64, 64) | DS |
| 6th BLG | (3, 128, 25) | (3, 64, 64) | (3, 64, 64) | DS |
| 7th BLG | (3, 25, 25) | (3, 64, 40) | (3, 64, 64) | DS |
| 8th BLG | | (3, 40, 25) | (3, 64, 64) | DS |
| 9th BLG | | (3, 25, 25) | (3, 64, 64) | DS |
| 10th BLG | | | (3, 64, 25) | DS |
| 11th BLG | | | (3, 25, 25) | DS |

wherein (K, Nᵢₙ, Nₒᵤₜ) refers to kernel size K, a number of input channels Nᵢₙ and a number of output channels Nₒᵤₜ; wherein a type of the layer indicates a type of convolution as non-separable, NS; or depth-wise separable, DS.

75. The apparatus of claim 74, wherein Θ defines the weights of a at least one, of some or all layers of a CNN used for the assigning of the classification value to each class of the second set.

76. The apparatus of claim 68, wherein the apparatus is configured to implement the soft classification by convoluting, batch-normalizing implementing a rectified linear (ReLU) activation function.

77. The apparatus of claim 68, wherein the apparatus is configured to implement the soft classification by use of a CNN that is adapted to use at least one of:
a quantization parameter, QP, information, e.g., a QP parameter, assigned to the current picture;
a reconstructed version of the current picture inbound to the first in-loop filter (e.g. which comprises a deblocking filter, DBF, or a DBF followed by SAO filter); and
a prediction signal of the current frame (e.g. predicted samples without prediction residual applied thereonto).

78. The apparatus of claim 68, wherein a 1^{st} basic layer group of a CNN of the soft classification is adapted to receive 8 input channels, advantageously exactly 8 input channels.

79. The apparatus of claim 78, wherein the 8 input channels comprise:
a quantization parameter, QP, information, e.g., a QP parameter, assigned to the current picture;
a reconstructed version of the current picture inbound to the first in-loop filter (e.g. which comprises a deblocking filter, DBF, or a DBF followed by SAO filter); and
a prediction signal of the current frame (e.g. predicted samples without prediction residual applied thereonto).
four output channels of a convolutional layer preceding and connected to the 1^{st} basic layer group; and
the pre-reconstructed samples.

80. The apparatus of claim 68, wherein the soft classification is to identify dominant features around a sample location.

81. The apparatus of claim 68, wherein the soft classification comprises a subsampler for providing a subsampling operator.

82. The apparatus of claim 81, wherein, for implementing the subsampling operator, the soft classification comprises a CNN that comprises a max pooling operator with 3×3 window followed by a 2DN downsampling with factor 2 that is applied to output channels of a second basic layer group of the CNN; wherein in a last layer of the CNN, the downsampling step is reverted by an upsampling with trained upsampling filters.

83. The apparatus of claim 68, wherein the soft classification is configured for a depth-wise separable convolution.

84. The apparatus of claim 83, wherein the depth-wise separable convolution comprises a filtering process in two parts; wherein a first part comprises a 2D convolution with a k₁×k₂ kernel that is performed independently over each input channel of the soft classification; wherein a second part comprises a full convolution but with 1×1 kernels that is applied across all channels.

85. The apparatus of claim 68, wherein the soft classification is adapted for applying a softmax function to a output channels of a last, e.g. seventh, basic layer group of the soft classification.

86. The apparatus of claim 68, wherein the softmax function comprises a structure based on
$${ϕ}_{k} ( i ) = \frac{exp ( {ψ}_{k} ( i ) )}{{\sum }_{ℓ = 1}^{L} exp ( {ψ}_{ℓ} ( i ) )} for i ∈ I .$$
wherein Φₖ(i) is interpretable as an estimated probability that the corresponding sample location i∈I is associated with a class of index k; Φₖ is a classification output; and ψₗ are the output channels of the last basic layer group.

87. The apparatus of claim 68, wherein the ALF is adapted for applying multiple 2D filters (fₖ) for different classes k to the classified samples.

88. The apparatus of claim 68, wherein the ALF is adapted for filtering the classified samples with a clipping function to reduce the impact of neighbour sample values when they are too different with the current sample value being filtered.

89. The apparatus of claim 68, wherein clipping function is based on the determination rule
$${\sum }_{i \neq ( 0 , 0 )} f ( i ) Clip ( y ( x + i ) - y ( x ) , ρ ( i ) )$$
to modify the filtering of the input signal y with a 2D-filter f at sample local x wherein ‘Clip’ is the clipping function defined by Clip(d; b)=min(b; max(−b; d)) and ρ(i) are trained clipping parameters used for the filtering process y*fₖ and for a first convolutional layer of a CNN of the soft classification.

90. The apparatus of claim 68, wherein coefficients of the FIR filters associated with the classes of first set of classes are signalled as part of the bitstream.

91. The apparatus of claim 68, wherein the FIR filters associated with the classes of first and second sets of classes comprise a diamond shape.

92. The apparatus of claim 58, configured to perform the mode switching in units of one or more of
coding treeroot blocks into which the current picture is pre-subdivided in rows and columns of coding treeroot blocks, and from which onwards the picture is subdivided into coding blocks by recursive multi-tree partitioning of the coding treeroot blocks,
coding blocks into which the current picture is subdivided by pre-subdividing the current picture into coding treeroot blocks in rows and columns of coding treeroot blocks, and subdividing the picture further from the coding treeroot blocks onwards by recursive multi-tree partitioning g of the coding treeroot blocks, and
slices of the current picture.

93. The apparatus of claim 58, configured to signal the mode switching by use of a syntax element in the bitstream.

94. The apparatus of claim 93, configured to signal the syntax element in the bitstream individually for
coding treeroot blocks into which the current picture is pre-subdivided in rows and columns of coding treeroot blocks, and from which onwards the picture is subdivided into coding blocks by recursive multi-tree partitioning of the coding treeroot blocks,
coding blocks into which the current picture is subdivided by pre-subdividing the current picture into coding treeroot blocks in rows and columns of coding treeroot blocks, and subdividing the picture further from the coding treeroot blocks onwards by recursive multi-tree partitioning g of the coding treeroot blocks, and
slices of the current picture.

95. The apparatus of claim 93, configured to perform the mode switching between by
estimating a measure of complexity incurred by the second in-loop filter or the one or more first modes of the second in-loop filter within a predetermined video or picture section so far, and
checking whether the estimation fulfills a predetermined criterion (e.g. exceeds a threshold), and if so, it is to be inferred that the syntax element, if same relates to the predetermined video or picture section,
assumes a predetermined value not corresponding to any first mode, or any first mode exceeding a predetermined complexity, or
has a decreased value domain which excludes the one or more first modes, or any first mode exceeding the predetermined complexity, and is decreased relative to a complete value domain the syntax element has outside the predetermined video or picture section, so that a bit rate for signaling at least one value in the decreased value domain, which does not correspond to any first mode, or any first mode exceeding the predetermined complexity, has a smaller bitrate consumption than compared to a corresponding value in the complete value domain.

96. The apparatus of claim 58, configured to perform the mode switching between based on an estimation of a measure of complexity incurred by the second in-loop filter or the one or more first modes of the second in-loop filter within a predetermined video or picture section so far by disabling the one or more first modes, or any first mode exceeding a predetermined complexity for the predetermined video or picture section if the estimation fulfills a predetermined criterion (e.g. exceeds a threshold).

97. The apparatus of claim 93, configured to perform the mode switching by
determining, within a predetermined picture area, a measure for prediction quality or prediction imperfection within the predetermined picture area, and
checking whether the measure for prediction or prediction imperfection fulfills a further predetermined criterion (e.g. indicates that the prediction is poorer than a threshold), and if so, it is to be inferred that the syntax element, if same relates to the predetermined picture area,
assumes a predetermined value not corresponding to any first mode, or any first mode exceeding a predetermined complexity, or
has a decreased value domain which excludes the one or more first modes, or any first mode exceeding the predetermined complexity, and is decreased relative to a complete value domain the syntax element has outside the predetermined picture area, so that a bit rate for signaling at least one value in the decreased value domain, which does not correspond to any first mode, or any first mode exceeding the predetermined complexity, has a smaller bitrate consumption than compared to a corresponding value in the complete value domain.

98. The apparatus of claim 58, configured to perform the mode switching based on measure for prediction quality or prediction imperfection within a predetermined picture area by disabling the one or more first modes, or any first mode exceeding the predetermined complexity, for the predetermined picture area if the measure for prediction quality or prediction imperfection fulfills a further predetermined criterion.

99. The apparatus of claim 97, wherein the measure for prediction quality or prediction imperfection includes one or more of
the prediction residual being zero within the predetermined picture area,
the areal fraction in which the prediction residual is zero,
a number of coded non-zero transform coefficients,
an energy of coded transform coefficients.

100. The apparatus of claim 97, wherein the predetermined picture area is a coding treeroot block, coding block, or slice.

101. The apparatus of claim 93, configured to perform the mode switching by
determining a prediction type or inter-prediction hierarchy level of a picture, and
checking whether the prediction type or inter-prediction hierarchy level fulfils an even further predetermined criterion, and if so, it is to be inferred that the syntax element, if same relates to the picture,
assumes a predetermined value not corresponding to any first mode, or any first mode exceeding a predetermined complexity, or
has a decreased value domain which excludes the one or more first modes, or any first mode exceeding a predetermined complexity, and is decreased relative to a complete value domain the syntax element has outside the picture, so that a bit rate for signaling at least one value in the decreased value domain, which does not correspond to any first mode, or any first mode exceeding the predetermined complexity, has a smaller bitrate consumption than compared to a corresponding value in the complete value domain.

102. The apparatus of claim 58, configured to perform the mode switching based on prediction type or inter-prediction hierarchy level of a picture by disabling the one or more first modes, or any first mode exceeding a predetermined complexity for the picture if the measure for prediction quality or prediction imperfection fulfills a even further predetermined criterion.

103. The apparatus of claim 101, wherein the prediction type indicates whether the picture is inter-predicted based on reference pictures preceding and succeeding the picture in presentation time order, with the even further predetermined criterion being fulfilled if this is the case, and/or the inter-prediction hierarchy level of a picture indicates a temporal hierarchy level of the picture in a GOP, with the even further predetermined criterion being fulfilled if the hierarchy level exceeds same threshold.

104. The apparatus of claim 93, configured to perform the mode switching by
checking whether for a predetermined picture portion has at least one reference picture which succeeds a picture of the predetermined picture portion in presentation time order, and
if so, it is to be inferred that the syntax element, if same relates to the predetermined picture portion,
assumes a predetermined value not corresponding to any first mode, or any first mode exceeding a predetermined complexity, or
has a decreased value domain which excludes the one or more first modes, or any first mode exceeding a predetermined complexity, and is decreased relative to a complete value domain the syntax element has outside the predetermined picture portion, so that a bit rate for signaling at least one value in the decreased value domain, which does not correspond to any first mode, or any first mode exceeding the predetermined complexity, has a smaller bitrate consumption than compared to a corresponding value in the complete value domain.

105. The apparatus of claim 58, configured to perform the mode switching whether for a predetermined picture portion at least one reference picture succeeds a picture of the predetermined picture portion in presentation time order by disabling the one or more first modes, or any first mode exceeding the predetermined complexity for the predetermined picture portion if this is the case.

106. The apparatus of claim 104, wherein the predetermined picture portion is a slice or a whole picture.

107. The apparatus of claim 93, configured to perform the mode switching by
checking whether a further predetermined picture portion is, within at least one block, or completely intra coded, and
if so, it is to be inferred that the syntax element, if same relates to the further predetermined picture portion,
assumes a predetermined value not corresponding to any first mode, or any first mode exceeding a predetermined complexity, or
has a decreased value domain which excludes each first mode, or any first mode exceeding a predetermined complexity, and is decreased relative to a complete value domain the syntax element has outside the further predetermined picture portion, so that a bit rate for signaling at least one value in the decreased value domain, which does not correspond to any first mode, or any first mode exceeding the predetermined complexity, has a smaller bitrate consumption than compared to a corresponding value in the complete value domain.

108. The apparatus of claim 58, configured to perform the mode switching whether a further predetermined picture portion is, within at least one block, or completely intra coded by disabling the one or more first modes, or any first mode exceeding a predetermined complexity for the further predetermined picture portion if this is the case.

109. The apparatus of claim 104, wherein the predetermined picture portion if a slice, a whole picture or a CTU or a CU.

110. The apparatus of claim 58, wherein the soft classification is adapted to provide for a number of at most 35000, e.g., 29873 trained parameters.

111. The apparatus of claim 58, wherein the second in-loop filter is configured to
perform the soft classification for first pre-reconstructed samples by assigning, for each first pre-reconstructed sample, a classification value to each of a first set of classes, with each of which an associated first FIR filter and a second filter is associated, and performing the adaptive in-loop filtering, in case of using the soft classification for the assigning the classification, by
applying, for each class of the first set of classes, the associated first FIR filter associated with the respective class onto the pre-reconstructed samples to obtain a first filtered version,
weighting, for each class of the first set of classes, the first filtered version at each sample position with the classification value assigned to the respective class for the first pre-reconstructed sample at the respective sample position to obtain an second filtered version,
applying, for each class of the first set of classes, the associated second FIR filter associated with the respective class onto the second filter version to obtain a third filtered version,
subjecting, for each second pre-filtered version, the third filtered version obtained for the classes of the first set, to a summation,
wherein for each class of the first set of classes coefficients, and/or a size and/or shape of a kernel of the second FIR filter are conveyed in the bitstream.

112. The apparatus of claim 58 wherein the second in-loop filter is configured to switch, and signal in the bitstream, between
performing the soft classification for first pre-reconstructed samples in a first manner by assigning, for each first pre-reconstructed sample, a classification value to each of a first set of classes, with each of which an associated FIR filter is associated, and performing the adaptive in-loop filtering, in case of using the soft classification for the assigning the classification, by applying, at each first pre-reconstructed sample, for each class of the first set of classes, the associated FIR filter associated with the respective class to the pre-reconstructed samples to obtain a filter result, and forming a weighted sum of the filter results of the first set of classes according to the classification values; and
performing the soft classification for first pre-reconstructed samples in a second manner by assigning, for each first pre-reconstructed sample, a classification value to each of a first set of classes, with each of which an associated first FIR filter and a second filter is associated, and performing the adaptive in-loop filtering, in case of using the soft classification for the assigning the classification, by
applying, for each class of the first set of classes, the associated first FIR filter associated with the respective class onto the pre-reconstructed samples to obtain a first filtered version,
weighting, for each class of the first set of classes, the first filtered version at each sample position with the classification value assigned to the respective class for the first pre-reconstructed sample at the respective sample position to obtain an second filtered version,
applying, for each class of the first set of classes, the associated second FIR filter associated with the respective class onto the second filter version to obtain a third filtered version,
subjecting, for each second pre-filtered version, the third filtered version obtained for the classes of the first set, to a summation,
wherein for each class of the first set of classes coefficients, and/or a size and/or shape of a kernel of the second FIR filter are conveyed in the bitstream.

113. The apparatus of claim 112, configured to perform the switching between performing the performing the soft classification for first pre-reconstructed samples in the first or second manner in units of one or more of
coding treeroot blocks into which the current picture is pre-subdivided in rows and columns of coding treeroot blocks, and from which onwards the picture is subdivided into coding blocks by recursive multi-tree partitioning of the coding treeroot blocks,
coding blocks into which the current picture is subdivided by pre-subdividing the current picture into coding treeroot blocks in rows and columns of coding treeroot blocks, and subdividing the picture further from the coding treeroot blocks onwards by recursive multi-tree partitioning g of the coding treeroot blocks, and
slices of the current picture;
Pictures of the video,
a sequence of Pictures of the video,
the video.

114. The apparatus of claim 58, configured to perform the switching between performing the soft classification for first pre-reconstructed samples in the first or second manner based on an estimation of a measure for multiplications per sample incurred by the second in-loop filter for the current picture so far by disabling the soft classification if the estimation fulfills a predetermined criterion (e.g. exceeds a threshold).

115. Methods performed by the above apparatus of claim 1 or 58.

116. A method for decoding a video from a bitstream, wherein the method comprises:
reconstruct, based on the bitstream, the video using block-based predictive decoding, transform-based residual decoding and a prediction loop into which an in-loop filter tool is serially connected, the in-loop filter tool comprising a serial connection of a first in-loop filtering and a second in-loop filtering,
wherein the second in-loop filtering is performed by subjecting pre-reconstructed samples of a current picture to an adaptive in-loop filtering, ALF,
wherein the second in-loop filtering performs, based on the bitstream, a mode switching
between (alternative 1)
one or more first modes of performing the adaptive in-loop filtering, and
one or more second modes of performing the adaptive in-loop filtering, wherein the one or more first modes are computationally more complex than the one or more second modes, or
between (alternative 2)
one or more first modes of performing the adaptive in-loop filtering, and
one or more second modes of performing the adaptive in-loop filtering, wherein the one or more first modes are computationally more complex than the one or more second modes, and
a third mode of bypassing the second in-loop filter, or
between (alternative 3)
one or more first modes of performing the adaptive in-loop filtering, with each of the first modes using a CNN, and
optionally, a second mode of bypassing the second in-loop filter.

117. A method for encoding a video into a bitstream, wherein the method comprises:
encode, into the bitstream, the video using block-based predictive encoding, transform-based residual encoding and a prediction loop into which an in-loop filter tool is serially connected, the in-loop filter tool comprising a serial connection of a first in-loop filter and a second in-loop filter,
wherein the second in-loop filtering is performed by subjecting pre-reconstructed samples of a current picture to an adaptive in-loop filtering, ALF,
wherein the second in-loop filtering performs, and signals in the bitstream, a mode switching
between (alternative 1)
one or more first modes of performing the adaptive in-loop filtering, and
one or more second modes of performing the adaptive in-loop filtering, wherein the one or more first modes are computationally more complex than the one or more second modes, or
between (alternative 2)
one or more first modes of performing the adaptive in-loop filtering, and
one or more second modes of performing the adaptive in-loop filtering, wherein the one or more first modes are computationally more complex than the one or more second modes, and
a third mode of bypassing the second in-loop filter, or
between (alternative 3)
one or more first modes of performing the adaptive in-loop filtering, with each of the first modes using a CNN, and
optionally, a second mode of bypassing the second in-loop filter.

118. A non-transitory digital storage medium having stored thereon a computer program for performing any method according to claims 115 to 117 when the computer program is run by a computer.

119. A bitstream generated by the above apparatus of claim 58.
